(19) United States
(12) Patent Application Publication
(10) Pub. No.: US 2013/0040017 A1
(43) Pub. Date: Feb. 14, 2013

(54) EDIBLE BATTER COMPOSITIONS AND METHODS OF PREPARING BATTER-COATED FOODS USING THE SAME

(71) Applicants: David White, Oxfordshire (GB); Peter Luker, Oxfordshire (GB)

(72) Inventors: David White, Oxfordshire (GB); Peter Luker, Oxfordshire (GB)

(21) Appl. No.: 13/579,053

(22) PCT Filed: Feb. 15, 2011
(86) PCT No.: PCT/GB2011/050286

§ 371 Date: Oct. 31, 2012

(30) Foreign Application Priority Data
Feb. 16, 2010 (GB) 1002610.2

(51) Int. Cl. A21D 10/04; A23L 1/325; A23L 1/31; A23L 1/01; A23P 1/08

(52) U.S. Cl. 426/61; 426/549; 426/552; 426/496; 426/439; 426/68; 426/291; 426/653; 426/94; 426/92

(57) ABSTRACT

The present invention relates to edible batter compositions which reduce fat uptake by absorption during cooking whilst maintaining characteristics of taste and texture, and to precursor compositions, methods of preparing food products and food products comprising the batter compositions of the present invention.

This invention relates to edible batter compositions for coating food substrates which are subsequently cooked, for example, by frying in fat and/or oil. More specifically, the invention relates to edible batter compositions which reduce the amount of fat that is absorbed when a batter-coated food product is cooked, for example, by frying in fat and/or oil, whilst maintaining desirable characteristics of taste and texture in the cooked food product. The invention also provides precursor compositions that can be used to prepare the edible batter compositions of the invention when combined with water. In further embodiments, the invention provides methods of preparing the inventive edible batter compositions and methods of preparing food products using the inventive edible batter compositions. Still further, the invention provides food products prepared using the edible batter compositions and the methods of the invention. Still further, the invention provides use of the edible batter compositions and precursor compositions of the invention in the preparation of food products.

Many food products are prepared by methods which comprise coating a food substrate with a coating of an edible batter composition in the form of a slurry and cooking the coated food substrate by frying in hot oil and/or fat. An example of this is battered fish found in traditional British fish and chip shops, where raw cod or other fish substrate is coated in a layer of wheat flour before being dipped in a tempura type batter. In another known cooking process, whole or formed pieces of chicken are coated with a layer of flour before being coated with an intermediate layer of a breading substance (e.g. breadcrumbs) and dipped in a tempura type batter. Food products prepared in these ways have a cooked batter coating having desirable characteristics of crispness and flavour that are attractive and appetising to consumers, and which also increase the weight and volume of the food product.

Battered products are made in a variety of ways on a variety of substrates in addition to those described above. Substrates may, for example, be selected from fish, poultry, meat, vegetable, mushroom or fruit. The substrate can be pre-cooked or part-cooked before coating in batter, or it may be raw. The substrate may also be hot, ambient, chilled or frozen when coated.

In commercial settings batter-coated food products are often pre-prepared in a food factory in a form which may be reheated or fully cooked in a commercial or domestic kitchen. In some cases, a food substrate having an uncooked coating of batter is simply chilled or frozen and packaged for delivery to consumers. More commonly, however, a food product is provided with a batter coating and cooked or part-cooked by frying in a food factory to set the batter. Part-cooking by frying is known in the industry by the term “par-frying”, and the products of such processes are referred to as “par-fried”. The term “full-frying” is used to refer to fully cooking food products by frying. The cooked or, more usually, part-cooked food product is subsequently chilled or frozen and packaged for delivery to consumers. The cooked or part-cooked products are then prepared for consumption by frying in fat and/or oil, or by oven baking. In many cases, the commercially prepared products are more complex than the traditional products described above, and comprise a plurality of coating layers to obtain a final product having characteristics of taste and texture, for example, that consumers find appealing.

As used herein, the term “tempura batter” refers to edible batter compositions that may be used as an outer coating for food substrates. Tempura batters are responsible for the initial crispness of a cooked batter coating when eaten, the visual appeal, and much of the flavour of the cooked batter-coated food product. Accordingly, cooked tempura batters require visual and structural qualities that are not required of adhesion batters. In the context of the present invention, the term “tempura batter” should not be interpreted as being limited solely to traditional Japanese tempura batter compositions, which require a specific recipe and preparation of the batter compositions to obtain the characteristic structure of Japanese tempura coatings.

As used herein, the term “adhesion batter” refers to edible batter compositions that are used to adhere an additional coating layer to a food substrate. The adhesion batter coating serves as an adhesive layer between the food substrate and the additional coating layer. The additional coating layer is formed from dry, granular substances known as “intermediates” and is selected based on the granulation, colour, flavour and crispness desired in the cooked coated food product. Examples of intermediates include breadcrumbs and cracker meal. The degree of adhesion of the intermediates may be controlled by altering the viscosity of the adhesion batter composition. Generally, more viscous adhesion batter compositions yield a higher pick-up of intermediates than less viscous compositions. An outer coating of a tempura batter composition is often applied over the intermediate layer.

A particular disadvantage of fried batter-coated food products is that a significant amount of fat and/or oil can be absorbed during frying, increasing the calorific value of the food products and reducing their nutritional value. In view of increasing consumer awareness about healthy eating, methods of reducing the fat and/or oil content of such food products are needed, preferably without reducing the flavour and visual appeal of the food products. Due to this, research and development into reduced fat products is continuously increasing.

Many fat blocking technologies have been developed and tested, including the addition of gums and gelling agents (such as pectin gum, methylcellulose gum, hydroxypropyl methylcellulose gum, xanthan gum, alginates and starches), or protein isolates (such as whey protein isolate, wheat protein isolate, or soy protein isolate) to batter compositions.

WO 96/38054 discloses the use of calcium pectins to resist absorption of oil during cooking of batter-coated and breaded food compositions.

Balasubramaniam et al. (Journal of Food Process Engineering, Volume 20, pages 17 to 29) disclose the use of a hydroxypropyl methylcellulose (HPMC) film coating for moisture retention and fat reduction during deep fat frying.

The use of HPMC or methylcellulose (MC) film-forming solutions is also disclosed by Mallikarjunan et al. (Lebensmittel-Wissenschaft and Technologie, Volume 30, 1997, pages 709 to 714).

U.S. Pat. No. 5,019,406 discloses the use of dietary fibre, such as powdered cellulose, as an additive in batter compositions to reduce the lipid retention in fried batter-coated foods.

U.S. Pat. No. 6,224,921 discloses the use of cold water-swelling rice-based starch products, such as pregelatinised rice flour, phosphorylated rice starch and pregelatinised acetylated rice starch, in fried batter compositions.

US 2002/0001659 discloses the use of alginic esters to retard oil absorption by fried foods, such as noodles, doughnuts and batter coatings.

Williams et al. (Journal of Food Science, Volume 64, 1999, pages 317 to 322) discloses the use of films formed by gellan, MC, and hydroxypropyl cellulose (HPC) gums to reduce fat absorption by fried foods.

The use of protein isolates to reduced fat uptake in fried foods has been described in U.S. Pat. No. 5,217,736, which describes the use of hydrophobic prolamines, such as zein, to coat foods with a protein latex barrier prior to frying.

U.S. Pat. No. 5,232,721 discloses the use of a protein selected from collagen, gelatine and casein to form a protein barrier to reduce fat uptake by fried foods.

While these technologies have had some success in reducing the fat and/or oil content of battered food products, product quality is significantly reduced to a level that is unacceptable to consumers. The above technologies are largely based on the formation of a barrier to retain moisture and block fat uptake. In particular, HPMC, MC and other gums, such as carboxymethylcellulose gum (CPC) are long chain molecules that gel on heating. The crispness of fried batter coatings is largely due to the product breaking up as the consumer chews the food. However, long chain molecules make the product stronger resulting in a chewy and/or tough texture in the final product.

There is therefore a need in the art for methods and compositions to reduce the uptake of fat and/or oil by fried foods without compromising the levels of product quality that are expected by consumers.

Unless specified otherwise, the terms “fat”, “oil” and “fat and/or oil” are used interchangeably herein to refer to edible fats and/or oils of animal or plant origin. Examples of edible oils of plant origin include sunflower oil, rapeseed oil, maize oil, groundnut oil, sesame oil, soybean oil, and palm oil.

Most research relating to reduced uptake of fat and/or oil in fried batter-coated food products is based on single-fry processes, i.e. processes in which a batter-coated food product is fully cooked for consumption in a single frying step. However, it will be appreciated that most pre-prepared batter-coated food products supplied to restaurants and consumers are part-cooked by frying in a factory environment (par-fried) and then fully cooked in a subsequent frying or oven baking step in a commercial or domestic kitchen.

It will be readily understood that absorption of fat and/or oil is of particular concern where the food product is subjected to two frying steps before consumption, as described above, i.e. a first frying step in a factory environment to cook or part-cook the food substrate and to set the batter, and a second frying step to prepare the food product for consumption. It is therefore important that any fat-reducing technology be capable of achieving fat reduction in a fully cooked food product, in the form in which it is consumed. If the fat blocking effect occurs only during the initial part-cooking step, and the end product when fully cooked has a standard fat level, then there is no benefit to the consumer. There is also therefore a need in the art for fat-reducing technologies that are capable of achieving fat reduction over two or more frying steps, and which retain desired taste and textural properties.

Furthermore, as noted above, most of the prior research in this area has focused on fat reduction techniques which lead to reduced product quality, for example taste and texture. The success of any fat reduction technology is highly dependent on the acceptability of the end product to consumers. It is therefore important that any fat-reducing technologies provide an end product that is appealing to consumers in terms of taste, texture and appearance.

One proposal for reducing the fat and/or oil uptake of fried foods is disclosed in U.S. Pat. No. 7,163,707. This document discloses a process that uses a protein or peptide composition derived from animal muscle protein. Processes for isolating the protein or peptide compositions used in the above process are described in U.S. Pat. No. 6,005,073, U.S. Pat. No. 6,288,216, and U.S. Pat. No. 6,451,975.

In accordance with U.S. Pat. No. 7,163,707, an acidic solution of the protein or peptide is combined with a wide variety of food types, for example by coating the food with the protein solution, injecting the protein solution into the food, or mixing the protein solution with the food. In particular, it is disclosed that the protein and/or peptide solution may be used in admixture with a number of food additives, including batter coatings. However, a particular disadvantage of the processes disclosed in U.S. Pat. No. 7,163,707 is that acidification of the protein solutions to pH 2.5 to 3.5 is essential. The acidification of the protein solution impairs the flavour of the cooked food product. In addition, a high amount of protein is needed in the batter compositions disclosed, which results in a tough and chewy product which is unacceptable to consumers. In many cases, it is also necessary to add ethanol to the batter composition to obtain acceptable fat reduction. However, the use of ethanol on an industrial scale is hazardous due to its flammability. Further, the cost of the large quantities of protein that are necessary is commercially prohibitive.

The present invention is based on the surprising discovery that a significant reduction in the uptake of fat and/or oil by fried batter-coated food substrates can be obtained when using an edible batter composition comprising a protein and/or peptide mixture derived from animal tissue, where the concentration of alkali metal ions in the edible batter composition is carefully controlled within a selected low range.

Without being bound by any particular theory, it is believed that alkali metal ions interfere with the protein structure, limiting its ability to reduce uptake of fat and/or oil. To overcome the presence of alkali metal ions, it is necessary in U.S. Pat. No. 7,163,707 to use large quantities of protein together with acidification merely to obtain an acceptable reduction in the uptake of fat and/or oil without any consideration of product quality. In addition, the use of acids causes a reduction in product quality as discussed above.

It has now surprisingly been found that by controlling the concentration of alkali metal ions in the batter composition, the amount of protein can be reduced without increasing the uptake of fat and/or oil by the batter composition. In addition, acidification of the batter composition has been found to be unnecessary to obtain an acceptable reduction in the uptake of fat and/or oil. As a result of these factors, a batter-coated food product may be obtained which does not suffer from the impairment of taste, texture and appearance that is associated with higher quantities of protein and acidification.

As a further benefit, it has been found that food substrates coated with the edible batter compositions of the present invention may be cooked over two or more frying steps, without affecting the ability of the batter compositions to reduce uptake of fat and/or oil. Accordingly, the batter compositions of the present invention are of particular benefit in the pre-preparation of food products in factories. However, it will be appreciated that the fat reduction is likewise observed in single-fry processes.

Thus, according to a first aspect of the present invention, there is provided an edible batter composition for frying in fat and/or oil, said edible batter composition comprising:
(a) 27 to 57 weight percent flour;
(b) 40 to 70 weight percent water; and
(c) 0.15 to 3.0 weight percent of a protein and/or peptide mixture derived from animal muscular tissue,
   and wherein the edible batter composition comprises less than or equal to 0.030 mol/kg of alkali metal ions.

As used herein, the term “alkali metal ions” refers to the Group I and Group II metal ions that are present in the edible batter compositions of the present invention, in particular those added in the form of leavening agents, seasonings, preservatives, or other additives. In general, the compositions of the present invention comprise predominately sodium, potassium and calcium ions. However, other Group I and Group II metal ions, such as lithium or magnesium ions, may sometimes also be present, although generally in lower quantities than sodium, potassium and calcium ions.

As used herein the term “alkali metal ions” is preferably not interpreted to include trace amounts of alkali metals that are naturally found in flour, although the term does include alkali metals present in additives that are added to certain types of flour, such as the leavening agents found in self-raising flour.

The edible batter compositions of the present invention are suitable for use as batter coatings for food substrates. Such coatings may take the form of adhesion batters or tempura batters, as defined above.

The edible batter compositions of the invention preferably comprise at least 45 weight percent water, and more preferably at least 50 weight percent water. The edible batter compositions of the invention preferably also comprise less than or equal to 65 weight percent water. Thus, the edible batter compositions of the invention preferably comprise from 45 to 65 weight percent water, and more preferably from 50 to 65 weight percent water.

It will be appreciated that references to the water content of the edible batter compositions of the invention do not include the natural moisture content of the flour in the composition.

The edible batter compositions of the present invention may contain up to 2.5 weight percent of the protein and/or peptide mixture, more preferably up to 2.0 weight percent, still more preferably up to 1.5 weight percent of the protein and/or peptide mixture, and most preferably up to 1.0 weight percent of the protein and/or peptide mixture.

Additionally, the edible batter compositions of the present invention may comprise at least 0.25 weight percent of the protein and/or peptide mixture, more preferably at least 0.4 weight percent of the protein and/or peptide mixture, and most preferably at least 0.5 weight percent of the protein and/or peptide mixture.

Thus, the edible batter compositions of the present invention preferably comprise from 0.25 to 2.0 weight percent of the protein and/or peptide mixture, and most preferably from 0.5 to 1.0 weight percent of the protein and/or peptide mixture.

The protein and/or peptide mixture derived from animal muscular tissue may be obtained from fish, poultry or meat.

As used herein, the term “fish” is used to refer to the flesh of aquatic species suitable for human consumption, and the term should be interpreted to include finfish, such as cod, pollock, haddock, plaice, whitebait, salmon and trout, as well as shellfish, such as crustaceans and molluscs, for example lobster, shrimp, crab and crayfish.

As used herein, the term “poultry” is used to refer to the flesh of bird species suitable for human consumption, such as chicken, turkey and duck.

As used herein, the term “meat” is used to refer to the flesh of mammalian species suitable for human consumption, to the exclusion of fish and poultry, such as pork, beef, venison, lamb and rabbit.

For example, the muscular tissue may be obtained from cod, pollock, chicken, turkey, duck, pork, beef, or venison. Preferably, the protein and/or peptide mixture is separated from other cellular components of the animal muscle tissue.

Where the edible batter composition is used to coat fish substrates, the protein and/or peptide mixture is preferably derived from fish.

Where the edible batter composition is used to coat poultry substrates, the protein and/or peptide mixture is preferably derived from poultry.

Where the edible batter composition is used to coat meat substrates, the protein and/or peptide mixture is preferably derived from meat.

As used herein, the term “protein” refers to proteins derived from animal muscular tissue without substantial modification of the protein structure. For instance, the proteins may be obtained from the animal muscular tissue by processes such as centrifugation or precipitation. The term “peptide” refers to proteinaceous substances obtained from animal muscle tissue and subjected to subsequent processing to reduce the length of the amino acid chains, typically using a proteolytic enzyme.

In a preferred embodiment the protein and/or peptide mixture is selected from:
(i) a protein mixture of myofibrillar and/or sarcoplasmic proteins derived from animal tissue; and/or
(ii) a peptide mixture prepared by enzymatic degradation of a protein mixture of myofibrillar and/or sarcoplasmic proteins derived from animal tissue.

Preferably, the protein and/or peptide mixture is substantially free of sarcomeres and myofibrils. Sarcomeres and myofibrils comprise strands of tissue which are visible using a microscope, and which are formed primarily of sarcoplasmic and myofibrillar proteins.

The protein and/or peptide mixture is preferably substantially free of membrane lipids and other non-membrane lipids.

Preferably, the protein mixture of myofibrillar and/or sarcoplasmic proteins (i), and/or the protein mixture of myofibrillar and/or sarcoplasmic proteins used to prepare the peptide mixture (ii) contains from 8 to 30 weight percent of sarcoplasmic proteins, more preferably from 10 to 30 weight percent of sarcoplasmic proteins, still more preferably from 15 to 30 weight percent of sarcoplasmic proteins, and most preferably from 18 to 30 weight percent of sarcoplasmic proteins.

The protein mixture of myofibrillar and/or sarcoplasmic proteins derived from animal tissue may be obtained by a process comprising the steps of: (i) providing particulate animal muscle tissue, where the particulate animal tissue is preferably free of internal organs, intestines and head of an animal; (ii) suspending the particulate animal muscle tissue in an aqueous acidic solution or an aqueous basic solution at a pH effective to solubilise a major proportion, and preferably substantially all of the available protein in the animal muscle tissue.

In step (ii), the pH of the aqueous acidic solution is preferably in the range of from 2.5 to 3.5, and the pH of the aqueous basic solution is preferably in the range from 10.5 to 11.5. Use of an aqueous acidic or basic solution in these pH ranges has the advantage that the myofibril and sarcomere tissue structure is substantially completely converted to solubilised protein so that the protein product is substantially free of myofibrils and sarcomeres. However, the pH is not so acidic or basic as to effect substantial degradation of the myofibrillar and sarcoplasmic proteins.

Preferably, the process further comprises the step of (iii) precipitating the proteins from the aqueous solution by adjusting the pH to a pH in the range of from 5.0 to 5.5 or by increasing the ion strength of the protein solution, or drying the protein solution (e.g. by spray drying). However, in some cases the acidic or basic protein solution can be used directly in the preparation of edible batter compositions according to the invention without further treatment.

Preferably, step (ii) further comprises the step of separating the solubilised proteins from insoluble materials, membrane lipids and other non-membrane lipids, for example by centrifugation.

The proteins may be further treated with a proteolytic enzyme to form the peptide mixture prepared by enzymatic degradation of a protein mixture of myofibrillar and sarcoplasmic proteins derived from animal tissue referred to above.

Protein and/or peptide mixtures of the type described above, and processes for obtaining them, are well-known to those of skill in the art. Reference in this regard is made to the disclosure of U.S. Pat. No. 6,005,073, U.S. Pat. No. 6,288,216, and U.S. Pat. No. 6,451,975.

Protein and/or peptide mixtures derived from animal muscular tissue are commercially available from Proteus Industries (Massachusetts, USA) under the trade name NutriLean®.

As used throughout the present application in relation to the present invention, the term “protein” should be understood to refer to the protein and/or peptide mixture described above, unless stated otherwise.

As noted above, the edible batter compositions of the present invention comprise less than or equal to 0.030 mol/kg of alkali metal ions. Preferably, the edible batter compositions comprise less than or equal to 0.029 mol/kg of alkali metal ions, more preferably less than or equal to 0.028 mol/kg of alkali metal ions, more preferably less than or equal to 0.027 mol/kg of alkali metal ions, even more preferably less than or equal to 0.026 mol/kg of alkali metal ions, even more preferably less than or equal to 0.025 mol/kg of alkali metal ions, still more preferably less than or equal to 0.024 mol/kg of alkali metal ions, still more preferably less than or equal to 0.023 mol/kg of alkali metal ions, still even more preferably less than or equal to 0.022 mol/kg of alkali metal ions, still even more preferably less than or equal to 0.021 mol/kg of alkali metal ions, and most preferably less than or equal to 0.020 mol/kg of alkali metal ions.

The edible batter compositions of the invention may preferably comprise at least 0.010 mol/kg of alkali metal ions, preferably at least 0.011 mol/kg of alkali metal ions, more preferably at least 0.012 mol/kg of alkali metal ions, more preferably at least 0.013 mol/kg of alkali metal ions, even more preferably, at least 0.014 mol/kg of alkali metal ions, even more preferably at least 0.015 mol/kg of alkali metal ions, still more preferably at least 0.016 mol/kg of alkali metal ions, still more preferably at least 0.017 mol/kg of alkali metal ions, and most preferably at least 0.018 mol/kg of alkali metal ions.

Where the edible batter compositions of the invention comprise from 0.15 to 0.29 weight percent of the protein and/or peptide mixture, they preferably comprise from 0.010 to 0.021 mol/kg of alkali metal ions.

Where the edible batter compositions of the invention comprise from 0.30 to 0.59 weight percent of the protein and/or peptide mixture, they preferably comprise from 0.010 to 0.022 mol/kg of alkali metal ions.

Where the edible batter compositions of the invention comprise from 0.60 to 0.89 weight percent of the protein and/or peptide mixture, they preferably comprise from 0.010 to 0.023 mol/kg of alkali metal ions.

Where the edible batter compositions of the invention comprise from 0.90 to 1.19 weight percent of the protein and/or peptide mixture, they preferably comprise from 0.010 to 0.024 mol/kg of alkali metal ions.

Where the edible batter compositions of the invention comprise from 1.20 to 1.49. weight percent of the protein and/or peptide mixture, they preferably comprise from 0.010 to 0.025 mol/kg of alkali metal ions.

Where the edible batter compositions of the invention comprise from 1.50 to 1.79 weight percent of the protein and/or peptide mixture, they preferably comprise from 0.010 to 0.026 mol/kg of alkali metal ions.

Where the edible batter compositions of the invention comprise from 1.80 to 2.09 weight percent of the protein and/or peptide mixture, they preferably comprise from 0.010 to 0.027 mol/kg of alkali metal ions.

Where the edible batter compositions of the invention comprise from 2.10 to 2.39 weight percent of the protein and/or peptide mixture, they preferably comprise from 0.010 to 0.028 mol/kg of alkali metal ions.

Where the edible batter compositions of the invention comprise from 2.40 to 2.69 weight percent of the protein and/or peptide mixture, they preferably comprise from 0.010 to 0.029 mol/kg of alkali metal ions.

Where the edible batter compositions of the invention comprise from 2.70 to 3.0 weight percent of the protein and/or peptide mixture, they preferably comprise from 0.010 to 0.030 mol/kg of alkali metal ions.

In many applications, edible batters, particularly tempura batters, contain a leavening system to provide desirable visual and textural properties to the cooked batter, increasing its appeal to consumers. In some cases, a leavening system may also be used in adhesion batters. As used herein, the term “leavening system” refers to any of a number of chemical and/or biological substances which release gas bubbles (usually carbon dioxide), which expand on heating so as to provide an open, airy texture to the cooked batter.

The edible batter compositions of the present invention may further comprise a leavening system, and preferably a chemical leavening system.

Chemical leavening systems suitable for use according to the present invention generally comprise at least one alkaline leavening agent and at least one acidic leavening agent which react together to form carbon dioxide gas.

Examples of suitable alkaline leavening agents which may be used according to the present invention include sodium bicarbonate, sodium carbonate, ammonium bicarbonate, ammonium carbonate, potassium bicarbonate, potassium carbonate, and potassium bitartrate.

Examples of suitable acidic leavening agents which may be used according to the present invention include monocalcium phosphate, dicalcium phosphate, monosodium phosphate, sodium aluminium phosphate, and sodium acid pyrophosphate.

Preferably, the chemical leavening system comprises sodium bicarbonate, sodium acid pyrophosphate and monocalcium phosphate.

It will be appreciated that a number of the chemical leavening agents mentioned above comprise alkali metals. Preferably, where a chemical leavening system is used, the chemical leavening system supplies greater than 90 weight percent of the alkali metal ions in the edible batter composition, and more preferably greater than 95 weight percent of the alkali metal ions in the edible batter composition. In this way, the desirable leavening effect can be maximised within the limits for the alkali metal content required by the invention and thus without increasing fat uptake. The use of flavour enhancers, such as sodium chloride, reduces the amount of leavening agent that may be used and therefore often results in a poorer quality product.

Where leavening agents are used, it is preferable that the water used to prepare the edible batter compositions of the invention is below ambient temperature, for example below 20° C., more preferably below 15° C., and most preferably between 5° C. and 10° C. In this way, reaction of the leavening agents prior to cooking the batter composition is suppressed, increasing the leavening effect that is obtained on cooking.

Where the batter composition of the invention is for use as an adhesion batter, the edible batter composition may be free of leavening agents.

As with all conventional edible batter compositions, the edible batter compositions of the present invention comprise a ‘flour’ component to provide structure to the batter composition. A variety of different flours can be used, and the type of flour can be selected to give a variety of tastes, textures and appearances to the cooked batter.

Particularly useful flour types include wheat flour, maize flour, rice flour and soya flour. Typically, the flour used to form the edible batter compositions of the present invention comprises:
(i) from 0 to 100 weight percent wheat flour, for example from 10 to 90 weight percent wheat flour, or from 20 to 80 weight percent wheat flour, or from 30 to 70 weight percent wheat flour;
(ii) from 0 to 100 weight percent maize flour, for example from 10 to 90 weight percent maize flour, or from 20 to 80 weight percent maize flour, or from 30 to 70 weight percent maize flour; and
(iii) from 0 to 30 weight percent rice flour, for example 0 to 20 weight percent rice flour, or from 0 to 10 weight percent rice flour.

Edible batter compositions containing flour as described above are of general applicability. These compositions may for instance be used for coating meat substrates.

The choice of flour used depends on a number of factors, including the taste and texture desired in the cooked batter composition, as well as processing requirements (for example degree of adhesion, and suitability for freezing, storage and reheating). In general, the edible batter compositions of the invention may be used across a wide range of food substrates. However, certain types of flour may be more preferred than others for certain food substrates.

In some cases it is desirable that the flour comprises predominantly wheat flour. For example, the flour used to form the edible batter compositions of the present invention may comprise:
(i) from 40 to 100 weight percent wheat flour, for example from 50 to 90 weight percent wheat flour, or from 60 to 80 weight percent wheat flour;
(ii) from 0 to 50 weight percent maize flour, for example from 10 to 40 weight percent maize flour, or from 20 to 30 weight percent maize flour; and
(iii) from 0 to 30 weight percent rice flour, for example 0 to 20 weight percent rice flour, or from 0 to 10 weight percent rice flour.

Edible batter compositions containing a high content of wheat flour are particularly suitable for coating fish substrates.

In other cases it is desirable that the flour comprises predominantly maize flour. For example, the flour used to form the edible batter compositions of the present invention may comprise:
(i) from 0 to 50 weight percent wheat flour, for example from 10 to 40 weight percent wheat flour, or from 20 to 30 weight percent wheat flour;
(ii) from 40 to 100 weight percent maize flour, for example from 50 to 90 weight percent maize flour, or from 60 to 80 weight percent maize flour; and
(iii) from 0 to 30 weight percent rice flour, for example 0 to 20 weight percent rice flour, or from 0 to 10 weight percent rice flour.

Edible batter compositions containing a high content of maize flour are particularly suitable for coating chicken substrates.

The properties of the edible batter compositions of the present invention may be modified by the addition of starches. References to starches herein relate to starches which are used in addition to the flour, and should not be interpreted so as to include the starch which is naturally present in the flour. The use of starches provides additional structure to the cooked batter compositions, further improving the taste and texture of the cooked batter.

The edible batter compositions may further comprise from 1.5 to 18 weight percent of native or modified starch. Preferably, the edible batter compositions comprise from 3 to weight percent of native or modified starch, and more preferably from 6 to 12 weight percent of native or modified starch.

As used herein “native starch” refers to starch recovered in the original form (i.e. unmodified) from a starch-bearing crop. Native starch may be contrasted with modified starch, which has undergone some degree of chemical and/or physical modification. Examples of starches which may be used according to the present invention include: native wheat starch, modified wheat starch, native maize starch, modified maize starch, native rice starch, modified rice starch, native pea starch, modified pea starch, native tapioca starch, modified tapioca starch, native potato starch, and/or modified potato starch.

The edible batter compositions of the present invention may further comprise one or more colouring agents to improve the visual appeal of the cooked batter. In particular, the colour of the batter can reflect the flavour of the food product, for example a hint of yellow for a lemon flavoured product. Examples of suitable colouring agents include: milk powder, skim milk powder, whey powder, dextrose, lactose, turmeric and/or paprika. Where colouring agents are used, they are preferably used in an amount of up to 10 weight percent of the edible batter composition.

The edible batter compositions of the present invention may optionally comprise seasonings, for example pepper. However, the use of salt is avoided so as not to increase the alkali metal content of the edible batter compositions beyond the levels required by the invention.

The edible batter compositions of the present invention may further comprise an edible fat and/or oil component. The use of an edible fat and/or oil component may improve the taste and/or texture of the cooked batter. In addition, the use of an oil component may provide processing advantages as discussed below. The edible fat and/or oil component is preferably used in an amount of up to 6 weight percent of the edible batter composition. However, consistent with the aim of the invention to reduce the fat content of the cooked batter compositions, the edible fat and/or oil component is preferably used in an amount of up to 4.5 weight percent of the edible batter composition, and more preferably up to 3 weight percent of the edible batter composition.

A beaded hard fat component may be used, for example an animal fat or a solid vegetable oil. The beaded hard fat melts when the batter is cooked to provide a more open texture to the cooked batter.

Alternatively, or in addition, a liquid vegetable oil may be used. For example, the edible batter composition may comprise at least one of sunflower oil, rapeseed oil, maize oil, groundnut oil, sesame oil, soybean oil, and palm oil.

Further reduction in the fat content of the cooked batter composition may be obtained by adding up to 5 weight percent of ethanol to the edible batter compositions of the present invention. However, in some food preparation environments the use of ethanol may be regarded as a fire hazard. Thus, in a further embodiment, the edible batter compositions of the present invention do not contain added ethanol.

The pH of the edible batter compositions of the present invention is preferably in the range of from 2.5 to 12.0. However, more acidic or alkaline batter compositions provide cooked batters having an unpleasant taste due to the presence of the pH modifying agents. For example, citric acid or phosphoric acid are conventionally used as acidifying agents, but impart a flavour which is unpleasant to consumers. Accordingly, the pH of the edible batter compositions is preferably in the range of from 4.0 to 10.0, and more preferably in the range of from 5.0 to 9.0. Preferably, the edible batter composition is free of additional acidifying or basifying agents, other than those required as part of the chemical leavening system.

One preferred edible batter composition according to the invention comprises:
(i) 35 to 45 weight percent of wheat flour and maize flour in a weight ratio of from 40:60 to 60:40;
(ii) 50 to 60 weight percent water;
(iii) 0.4 to 1.0 weight percent of a protein and/or peptide mixture as described above;
(iv) 2 to 6 weight percent starch, preferably wheat starch;
(v) 0.15 to 0.3 weight percent of a mixture of sodium acid pyrophosphate and sodium bicarbonate in approximately neutralising amounts;
(vi) 0 to 3 weight percent whey powder; and
(vii) 0 to 0.5 weight percent of black pepper.

This edible batter composition is particularly useful for coating chicken substrates. As noted above, the protein and or peptide mixture is preferably derived from chicken when the edible batter composition is used to coat chicken substrates.

Another preferred edible batter composition according to the invention comprises:
(i) 35 to 45 weight percent of wheat flour and maize flour in a weight ratio of from 10:90 to 30:70;
(ii) 50 to 60 weight percent water;
(iii) 0.4 to 1.0 weight percent of a protein and/or peptide mixture as described above;
(iv) 2 to 6 weight percent starch, preferably wheat starch;
(v) 0.15 to 0.3 weight percent of a mixture of sodium acid pyrophosphate and sodium bicarbonate in approximately neutralising amounts; and
(vi) 0 to 3 weight percent whey powder.

This edible batter composition is particularly useful for coating fish substrates. As noted above, the protein and or peptide mixture is preferably derived from fish when the edible batter composition is used to coat fish substrates.

In another aspect, the present invention provides precursor compositions for preparing the edible batter compositions defined above, the precursor compositions comprising:
(a) 45 to 95 weight percent flour; and
(b) 0.25 to 5.0 weight percent of a dry protein and/or peptide mixture derived from animal muscular tissue,
   and wherein the precursor compositions comprise less than or equal to 0.050 mol/kg of alkali metal ions.

In general, the precursor compositions are substantially dry, substantially powder compositions that may be reconstituted with water to provide the edible batter compositions defined above. As used herein, the term “substantially dry” should be interpreted as meaning that the precursor compositions of the invention comprise no more than 10 weight percent of water, more preferably no more than 5 weight percent of water, not including moisture that is naturally present in flour.

The precursor compositions of the present invention may be used to prepare adhesion batters or tempura batters.

The precursor compositions preferably contain up to 4.1 weight percent of the protein and/or peptide mixture, more preferably up to 3.4 weight percent, still more preferably up to 2.5 weight percent of the protein and/or peptide mixture, and most preferably up to 1.7 weight percent of the protein and/or peptide mixture.

The precursor compositions preferably comprise at least 0.4 weight percent of the protein and/or peptide mixture, more preferably at least 0.67 weight percent of the protein and/or peptide mixture, and most preferably at least 0.8 weight percent of the protein and/or peptide mixture.

Thus, the precursor compositions preferably comprise from 0.4 to 3.4 weight percent of the protein and/or peptide mixture, and more preferably from 0.8 to 1.7 weight percent of the protein and/or peptide mixture.

As noted above, the precursor compositions of the present invention comprise less than or equal to 0.050 mol/kg of alkali metal ions. Preferably, the precursor compositions of the invention comprise less than or equal to 0.048 mol/kg of alkali metal ions, more preferably less than or equal to 0.047 mol/kg of alkali metal ions, more preferably less than or equal to 0.045 mol/kg of alkali metal ions, even more preferably less than or equal to 0.043 mol/kg of alkali metal ions, even more preferably less than or equal to 0.042 mol/kg of alkali metal ions, still more preferably less than or equal to 0.040 mol/kg of alkali metal ions, still more preferably less than or equal to 0.038 mol/kg of alkali metal ions, still even more preferably less than or equal to 0.037 mol/kg of alkali metal ions, still even more preferably less than or equal to 0.035 mol/kg of alkali metal ions, and most preferably less than or equal to 0.033 mol/kg of alkali metal ions.

The precursor compositions of the invention may preferably comprise at least 0.017 mol/kg of alkali metal ions, more preferably at least 0.018 mol/kg of alkali metal ions, more preferably at least 0.020 mol/kg of alkali metal ions, even more preferably at least 0.022 mol/kg of alkali metal ions, still more preferably, at least 0.023 mol/kg of alkali metal ions, and most preferably at least 0.025 mol/kg of alkali metal ions.

Where the edible batter compositions of the invention comprise from 0.25 to 0.49 weight percent of the protein and/or peptide mixture, they preferably comprise from 0.017 to 0.035 mol/kg of alkali metal ions.

Where the precursor compositions of the invention comprise from 0.50 to 0.99 weight percent of the protein and/or peptide mixture, they preferably comprise from 0.017 to 0.037 mol/kg of alkali metal ions.

Where the precursor compositions of the invention comprise from 1.00 to 1.49 weight percent of the protein and/or peptide mixture, they preferably comprise from 0.017 to 0.038 mol/kg of alkali metal ions.

Where the precursor compositions of the invention comprise from 1.50 to 1.99 weight percent of the protein and/or peptide mixture, they preferably comprise from 0.017 to 0.040 mol/kg of alkali metal ions.

Where the precursor compositions of the invention comprise from 2.00 to 2.49. weight percent of the protein and/or peptide mixture, they preferably comprise from 0.017 to 0.042 mol/kg of alkali metal ions.

Where the precursor compositions of the invention comprise from 2.50 to 2.99 weight percent of the protein and/or peptide mixture, they preferably comprise from 0.017 to 0.043 mol/kg of alkali metal ions.

Where the precursor compositions of the invention comprise from 3.00 to 3.49 weight percent of the protein and/or peptide mixture, they preferably comprise from 0.017 to 0.045 mol/kg of alkali metal ions.

Where the precursor compositions of the invention comprise from 3.50 to 3.99 weight percent of the protein and/or peptide mixture, they preferably comprise from 0.017 to 0.047 mol/kg of alkali metal ions.

Where the precursor compositions of the invention comprise from 4.00 to 4.49 weight percent of the protein and/or peptide mixture, they preferably comprise from 0.017 to 0.048 mol/kg of alkali metal ions.

Where the precursor compositions of the invention comprise from 4.50 to 5.0 weight percent of the protein and/or peptide mixture, they preferably comprise from 0.017 to 0.050 mol/kg of alkali metal ions.

The precursor compositions of the present invention may further comprise a chemical or biological leavening system. As noted above, a chemical or biological leavening system is of particular benefit when the precursor compositions of the invention are used to prepare a tempura batter as defined above. However, in some cases, a leavening agent may also be used where the precursor compositions of the invention are used to prepare an adhesion batter as defined above.

The leavening system is preferably a chemical leavening system as described above. The chemical leavening system preferably supplies greater than 90 weight percent of the alkali metal ions in the precursor compositions, and more preferably greater than 95 weight percent of the alkali metal ions in the precursor compositions, so as to maximise the content of the leavening agent in the precursor compositions without exceeding the maximum alkali metal content of the precursor compositions required by the invention.

The flour used in the precursor compositions of the present invention preferably comprises one or more of wheat flour, maize flour, rice flour and soya flour. Typically, the flour used to form the precursor compositions of the present invention comprises:
(i) from 0 to 100 weight percent wheat flour, for example from 10 to 90 weight percent wheat flour, or from 20 to 80 weight percent wheat flour, or from 30 to 70 weight percent wheat flour;
(ii) from 0 to 100 weight percent maize flour, for example from 10 to 90 weight percent maize flour, or from 20 to 80 weight percent maize flour, or from 30 to 70 weight percent maize flour; and
(iii) from 0 to 30 weight percent rice flour, for example 0 to 20 weight percent rice flour, or from 0 to 10 weight percent rice flour.

Precursor compositions containing flour as described above are of general applicability. These compositions may for instance be used for coating meat substrates.

As noted above, the choice of flour used depends on a number of factors, including the taste and texture desired in the cooked batter composition, as well as processing requirements (for example degree of adhesion, and suitability for freezing, storage and reheating).

Thus, the flour may comprise predominantly wheat flour. For example, the flour used to form the precursor compositions of the present invention could comprise:
(i) from 40 to 100 weight percent wheat flour, for example from 50 to 90 weight percent wheat flour, or from 60 to 80 weight percent wheat flour;
(ii) from 0 to 50 weight percent maize flour, for example from 10 to 40 weight percent maize flour, or from 20 to 30 weight percent maize flour; and
(iii) from 0 to 30 weight percent rice flour, for example 0 to 20 weight percent rice flour, or from 0 to 10 weight percent rice flour.

The flour may alternatively comprise predominantly maize flour. For example, the flour used to form the precursor compositions of the present invention could comprise:
(i) from 0 to 50 weight percent wheat flour, for example from 10 to 40 weight percent wheat flour, or from 20 to 30 weight percent wheat flour;
(ii) from 40 to 100 weight percent maize flour, for example from 50 to 90 weight percent maize flour, or from 60 to 80 weight percent maize flour; and
(iii) from 0 to 30 weight percent rice flour, for example 0 to 20 weight percent rice flour, or from 0 to 10 weight percent rice flour.

The precursor compositions of the present invention may further comprise a starch component. As above, references to starches herein relate to starches which are used in addition to the flour, and should not be interpreted so as to include the starch which is naturally present in the flour.

Thus, the precursor compositions of the present invention may further comprise from 2.5 to 30 weight percent of native or modified starch. Preferably, the precursor compositions comprise from 5 to 25 weight percent of native or modified starch, and more preferably from 10 to 20 weight percent of native or modified starch. Examples of suitable starches are provided above.

The precursor compositions of the present invention may further comprise one or more colouring agents. For example, the colouring agents may be selected from: milk powder, skim milk powder, whey powder, dextrose, lactose, turmeric extract and/or paprika extract. Where colouring agents are used, they are preferably used in an amount of up to 16 weight percent of the precursor composition.

The precursor compositions of the present invention may optionally comprise seasonings, for example pepper. However, the use of salt is avoided so as not to increase the alkali metal content of the precursor compositions beyond the levels required by the invention.

The precursor compositions of the present invention may further comprise an edible fat and/or oil component as described above. The edible fat and/or oil component is preferably used in an amount of up to 10 weight percent of the precursor composition.

The precursor compositions of the present invention preferably provide edible batter compositions having a pH in the range of from 2.5 to 12.0 when 40 to 70 parts by weight of water are added to 60 to 30 parts by weight of the precursor composition, to obtain a total of 100 parts by weight. More preferably, the precursor compositions provide edible batter compositions having a pH in the range of from 4.0 to 10, for example in the range of from 5.0 to 9.0, when 40 to 70 parts by weight of water are added to 60 to 30 parts by weight of the precursor composition, to obtain a total of 100 parts by weight.

In some cases it may be preferred that the precursor compositions of the present invention provide edible batter compositions having a pH in the range of from 4.0 to 6.5, and more preferably in the range of from 4.5 to 5.5.

In other cases it may be preferred that the precursor compositions of the present invention provide edible batter compositions having a pH in the range of from 7.5 to 10.0, and more preferably in the range of from 8.0 to 9.0.

Preferably, the precursor compositions are free of additional acidifying or basifying agents, other than those required as part of the chemical leavening system.

One preferred precursor composition according to the invention comprises:
(i) 82 to 92 weight percent of wheat flour and maize flour in a weight ratio of from 40:60 to 60:40;
(ii) 0.9 to 2.2 weight percent of a protein and/or peptide mixture as described above;
(iii) 5 to 15 weight percent starch, preferably wheat starch;
(iv) 0.3 to 0.7 weight percent of a mixture of sodium acid pyrophosphate and sodium bicarbonate in approximately neutralising amounts;
(v) 0 to 5 weight percent whey powder; and
(vi) 0 to 1.0 weight percent of black pepper.

This precursor composition is particularly useful for the preparation of edible batter compositions for coating chicken substrates. As noted above, the protein and or peptide mixture is preferably derived from chicken when the edible batter composition is used to coat chicken substrates.

Another preferred precursor composition according to the invention comprises:
(i) 82 to 92 weight percent of wheat flour and maize flour in a weight ratio of from 10:90 to 30:70;
(ii) 0.9 to 2.2 weight percent of a protein and/or peptide mixture as described above;
(iii) 5 to 15 weight percent starch, preferably wheat starch;
(iv) 0.3 to 0.7 weight percent of a mixture of sodium acid pyrophosphate and sodium bicarbonate in approximately neutralising amounts; and
(v) 0 to 5 weight percent whey powder.

This precursor composition is particularly useful for the preparation of edible batter compositions for coating fish substrates. As noted above, the protein and or peptide mixture is preferably derived from fish when the edible batter composition is used to coat fish substrates.

The precursor compositions of the invention may be mixed using standard ribbon mixers or paddle mixers that are known in the art. Under standard operating conditions, such mixers may be used to mix batches of 500 kg to 1500 kg of dry batter compositions, such as the precursor compositions of the invention. A typical mixing time of from 1.5 to 2 minutes is used with the mixer operating at standard operating speed. The mixing time may be up to three minutes for dry batter compositions comprising oil.

In general, the edible batter compositions of the present invention may be prepared simply by combining the components mentioned above to form a slurry, for example in a food mixer. Preferably, the edible batter compositions of the present invention may be prepared by combining 40 to 70 parts by weight of water with 60 to 30 parts by weight of a precursor composition as defined above, to obtain a total of 100 parts by weight. More preferably, 45 to 65 parts by weight of water are combined with 55 to 35 parts by weight of a precursor composition as defined above, to obtain a total of 100 parts by weight. Still more preferably, 50 to 65 parts by weight of water are combined with 50 to 35 parts by weight of a precursor composition as defined above, to obtain a total of 100 parts by weight.

The edible batter compositions of the present invention may typically be prepared by two different types of mixing: (i) automatic mixing—a viscosity is preset and a mixing machine mixes the batter composition to the required viscosity—this can be a batch process or a continuous process; or (ii) manual mixing—set amounts of water and dry batter components are manually added to a mixing machine.

Most commercial food factories use the automatic method due to the large volumes of batter that are processed. Mixing may be done by a high shear mixing blade, or some mixers work by passing the components of the batter mix through a pump. There is also a method of mixing wherein the dry batter components are dropped into a water vortex for low shear mixing. Such methods are well within the knowledge of the person of skill in the art.

As noted above, the edible batter compositions of the present invention are preferably mixed using cold water to minimise reaction of the raising agents before frying. It is also preferred that gentle shear mixing is used with minimal mixing times, as over-mixing can result in a significant proportion of the raising agents reacting in the batter mixer. Incorrect mixing does not have an effect on the fat reduction obtained using the edible batter compositions of the invention, however it may have a negative effect of the texture of the cooked batter.

In some cases it has been found that a further fat reduction may be obtained by preparing the edible batter compositions of the present invention in specific ways. More specifically, it has been found that a further improvement in fat reduction is obtained by preparing the edible batter compositions of the present invention in ways which ensure that the protein and/or peptide component is fully hydrated by the water component. It is believed that simply combining the individual components may lead to a situation where the other components of the edible batter compositions of the present invention compete with the protein and/or peptide component for the water, such that the protein may not be fully hydrated. The present inventors have therefore also developed precursor compositions and methods of preparing the compositions of the present invention which ensure that the protein component in the edible batter compositions of the present invention is fully hydrated.

The present invention therefore also provides precursor compositions comprising an edible oil component as defined above, wherein the precursor compositions may be prepared by a process that comprises the steps of:
(i) mixing all of the components of the precursor composition except for the protein and/or peptide mixture in a mixing apparatus so as to form a blended composition coated by the edible fat and/or oil; and
(ii) mixing the dry protein and/or peptide mixture with the blended composition from step (i) such that the dry protein and/or peptide mixture remains substantially uncoated by the edible fat and/or oil.

This precursor composition may be combined with water as described above to form an edible batter composition according to the present invention.

Preferably, the mixing in step (i) is continued until such a point that the blended composition has a uniform consistency. By “uniform consistency” is meant that the components of the blended composition are dispersed such that further mixing of the composition will not produce a composition of greater uniformity.

Typically the mixing time in step (ii) is approximately 5 to 40% of the mixing time required to obtain a uniform consistency in step (i), more preferably, 5 to 30% of the mixing time in step (i), still more preferably, 5 to 20% of the mixing time in step (i), and most preferably, 5 to 10% of the mixing time in step (i). In addition, the mixing in step (ii) is preferably carried out with mixing at a slower speed than in step (i), for instance with mixing at half the speed of step (i). These conditions ensure that the dry protein and/or peptide mixture remains substantially uncoated by the edible fat and/or oil.

When using a ribbon or paddle mixer as described above to prepare precursor compositions according to the process described above, a uniform consistency in step (i) is usually obtained after a period of 4 to 5 minutes mixing. After the protein and/or peptide mixture has been added, the resulting mixture may be blended for up to 2 minutes further, for example up to 1.5 minutes further, at half the standard operating speed, to provide a precursor composition in which the dry protein and/or peptide mixture remains substantially uncoated by the edible fat and/or oil.

It is believed that the coating of oil that is provided over the components of the precursor composition except for the protein and/or peptide mixture slows down the interaction of those components with water. The protein and/or peptide mixture is substantially uncoated by the edible oil. When water is added to the precursor composition, the protein is able to hydrate fully without having to compete with the remaining components of the edible batter compositions for water.

In another aspect, the present invention provides a method of preparing an edible batter composition as defined above, the method comprising the steps of:
(i) dissolving the protein and/or peptide mixture in the water to form a protein and/or peptide solution; and
(ii) combining the protein and/or peptide solution from step (i) with the remaining components of the edible batter composition to form a slurry.

In this aspect of the invention, the protein and/or peptide mixture is dissolved in the water prior to contact with the remaining components of the edible batter composition and therefore is able to hydrate fully without competition for water.

In a further aspect, the present invention provides a method of preparing a food product comprising providing a food substrate with a coating layer of an edible batter composition as defined in any aspect of the present invention, and frying the batter-coated food substrate in oil and/or fat to provide a cooked or part-cooked batter-coated food substrate.

It has been found that food products prepared using the edible batter compositions according to any aspect of the present invention, typically absorb 15 to 50 percent less fat and/or oil during frying, for example 25 to 35 percent less fat and/or oil, than other known batter compositions. The fat reduction is also greater than for batter compositions comprising protein and/or having large amounts of alkali metal ions.

In accordance with the present invention, the food substrate may, for example, be selected from fish, poultry, meat, vegetable or fruit.

In accordance with this aspect of the invention:
The term “fish” is used to refer to the flesh of aquatic species suitable for human consumption, and the term should be interpreted to include finfish, such as cod, pollock, haddock, plaice, whitebait, salmon and trout, as well as shellfish, such as crustaceans and molluscs, for example lobster, shrimp, crab and crayfish.
The term “poultry” is used to refer to the flesh of bird species suitable for human consumption, such as chicken, turkey and duck.
The term “meat” is used to refer to the flesh of mammalian species suitable for human consumption, to the exclusion of fish and poultry, such as pork, beef, venison, lamb and rabbit.

The food substrates used according to the invention may be whole or they may be formed. An example of a whole food substrate would be chicken breast fillet; the fillet is cut from the chicken. A formed substrate is often a cheaper product, a formed chicken breast will be made from minced chicken meat moulded or pressed into the shape of a chicken breast.

Where the food substrate is selected from fish, poultry or meat, it is preferred that the protein and/or peptide mixture is derived from the same type of animal source as the food substrate. Thus, where the food substrate is selected from poultry, the protein and/or peptide mixture is also preferably derived from poultry; where the food substrate is selected from fish, the protein and/or peptide mixture is also preferably derived from fish; and where the food substrate is selected from meat, the protein and/or peptide mixture is also preferably derived from meat.

In many commercial environments, food products are prepared in a factory and then chilled or frozen before being supplied to restaurants or to domestic consumers, and subsequently defrosted and/or reheated and/or fully cooked in the restaurant or in domestic kitchens. Accordingly, this aspect of the present invention may therefore comprise a further step in which the cooked or part-cooked batter-coated food substrate is subsequently chilled or frozen. Where the chilled or frozen batter-coated food substrate is cooked, it may be reheated for consumption by frying in oil and/or fat and/or by oven baking.

As noted above, the edible batter compositions of the present invention comprise a low molar concentration of alkali metal ions. In particular, the use of salt as a flavour enhancer in the edible batter compositions of the invention is preferably avoided as this reduces the amount of alkali metal-containing leavening agents that may be used. In some cases, however, this can result in a batter coating which is not as flavourful as consumers would expect. Thus, where the cooked or part-cooked batter-coated food substrate is subsequently frozen, this aspect of the invention may further comprise the step of spraying the frozen batter-coated food substrate with a flavour-enhancing quantity of salt water before or after freezing the batter-coated food substrate. The salt water freezes on contact with the frozen batter-coated food substrate, and provides an immediate salt flavour when the batter-coated food substrate is prepared for consumption (either by reheating, as above, of by further cooking as described below). Further, by providing the salt after the batter-coated food substrate has been cooked or part-cooked, the additional salt does not lead to an increase in the fat content of the food product, even where a subsequent frying step is used.

The methods of the present invention may also comprise a further step in which the, optionally chilled or frozen, part-cooked batter-coated food substrate is subsequently fully cooked by frying in oil and/or fat and/or by oven baking. In this regard, it is noted that not only are the edible batter compositions of the present invention capable of reducing fat uptake by coated food products that are cooked by a method involving a single frying step (i.e. which are fully cooked in a single frying step, or which are part-cooked by frying and then fully cooked by oven baking), a fat reduction is also observed when the food product is cooked by two or more frying steps (for instance, a first frying step in a factory to part-cook the food product, and a second frying step in a restaurant or a domestic kitchen to fully cook the food product for consumption). It will be understood that the present invention also includes two or more cooking steps where the first step is a frying step and the second is a baking step. Other combinations will immediately be evident.

In its simplest form, the method of preparing a food product according to the present invention may simply comprise applying the edible batter composition of the invention directly to the surface of the food substrate and subsequently frying the coated food substrate in fat and/or oil to provide the cooked or part-cooked batter-coated food substrate. However, in practice, this often results in low pick-up of the edible batter composition and poor adhesion of the edible batter composition coating to the food substrate. More preferably, therefore, the food substrate is provided with a number of coating layers of which at least one layer is of an edible batter composition according to the present invention, as defined above.

Preferably, where the food substrate is provided with a plurality of coating layers, at least the outer coating layer is of an edible batter composition according to the present invention.

In addition to the edible batter compositions of the present invention, the coatings that may be applied to the food substrates in accordance with this aspect of the invention include a predust layer, one or more layers of a conventional batter composition and one or more layers of an intermediate.

As used herein, the term “predust” refers to a blend of dry ingredients, usually based on flour, starches, or breadcrumbs. The purpose of a predust is to dry the surface of a wet food substrate to improve the adhesion of the batter compositions. Wet batter compositions often adhere poorly to wet food substrates.

For example, a conventional predust composition may comprise wheat flour and/or maize flour and/or rice flour, optionally with the addition of starch to improve adhesion and cohesion. For example wheat, maize, tapioca or potato starches may be used, both in native and modified forms. Adhesive starches are often modified and are used at medium to high levels in the predust to provide the best results, with 20 to 40 weight percent being typical. The predust may also comprise dry protein, for example wheat gluten, egg protein or dairy protein. Protein in the predust adheres to protein in the substrate, significantly improving the adhesion of the predust, even where low quantities of protein are used.

Predusts may also comprise basic breadcrumb, or rusk. Rusk comes in a variety of particle sizes and may be used on its own as a cheap predust, or as a carrier for other functional ingredients or flavourings. Rusk is very dry and can absorb large quantities of water, and this quality makes it particularly suitable as a predust. It is often used oiled as it can be extremely dusty.

As used herein, the term “intermediate” refers to a granulated flowing powder based on, for example, breadcrumbs, flour, rusk, corn meal, or cracker meal. Intermediates are used as a cheap way to add bulk and weight to a food product. They are usually used between an adhesion batter and a tempura batter, but can also be used between a predust and a tempura batter.

Three types of breadcrumbs are typically used in intermediates. These are standard baked breadcrumb having a range of particle sizes, rusk, and extruded crumb. Extruded crumb is sometimes added so that it shows through the batter. For example, extruded crumb having a half-moon appearance may be added so that the tempura batter on to will have a bumpy, rippled appearance when cooked.

Flour may also be used to bulk out intermediates, although too much flour can make the intermediate dense, impairing the texture of the final product.

Intermediates are protected from direct contact with the hot oil and/or fat during frying and are sometimes therefore used to carry flavours and other additives which would otherwise be damaged by the heat. As above, oil is sometimes added to intermediates to reduce dust. Flavours may also be applied to predusts, or may be used in adhesion batter layers. As the flavour is closer to the substrate, heat damage of the flavourings is suppressed.

As used herein, the term “conventional batter composition” refers to prior art batter compositions consisting substantially of flour, water and leavening agents.

A variety of combinations of predusts, intermediates, adhesion batters and tempura batters may be contemplated by the skilled person. For example, a coating procedure could be selected from one or more of the following:
1. Substrate, tempura, fry, chill/freeze
2. Substrate, predust, tempura, fry, chill/freeze
3. Substrate, predust, adhesion batter, intermediate, tempura, fry, chill/freeze
4. Substrate, adhesion batter, intermediate, tempura, fry, chill/freeze
5. Substrate, adhesion batter, adhesion batter, intermediate, tempura, fry, chill/freeze
6. Substrate, adhesion batter, intermediate, adhesion batter, intermediate, tempura, fry, chill/freeze
7. Substrate, predust, cook, adhesion batter, intermediate, tempura, fry, chill/freeze
8. Substrate, predust, cook, intermediate, tempura, fry, chill/freeze
9. Substrate, tempura, fry, cook, chill/freeze
10. Substrate, predust, tempura, fry, cook, chill/freeze
11. Substrate, predust, adhesion batter, intermediate, tempura, fry, cook, chill/freeze
12. Substrate, adhesion batter, intermediate, tempura, fry, cook, chill/freeze
13. Substrate, adhesion batter, adhesion batter, intermediate, tempura, fry, cook, chill/freeze.

Other combinations are possible as would immediately be appreciated by those of skill in the art. In particular, it is not excluded that an intermediate could form the outer coating layer, where the edible batter composition of the invention is used as an adhesion batter (for example, in the preparation of breadcrumb-coated food substrates).

Where the food substrate is provided with a number of coating layers, it is preferred that any coating layer that is immediately adjacent to the edible batter composition of the invention has a low alkali metal ion content. This avoids leaching of alkali metal ions into the edible batter compositions of the invention, which can cause increased uptake of fat and/or oil during frying. Typically, where the edible batter composition of the invention forms the outer coating layer (i.e. a tempura batter), the intermediate or predust layer below the outer coating layer is low in alkali metal ions.

It is also possible that, where a coating layer is not immediately adjacent to the edible batter composition of the invention, that coating layer may have an increased salt content to compensate for the low salt content of the edible batter composition and any layer that is adjacent to it. Preferably, there should be at least one coating layer that is low in alkali metal ions between a layer of the edible batter composition of the invention and a coating layer having increased salt content. More preferably, there should be at least two coating layers between a layer of the edible batter composition of the invention and a coating layer having increased salt.

Intermediates and predusts may be applied using a preduster or a breadcrumber. The food substrate is carried through the preduster or breadcrumber on a belt and is usually dropped onto the predust or intermediate to coat the bottom surface while predust is dropped onto the top surface. Excess predust or intermediate is shaken and/or blown off of the food substrate. Between 1 and 8 weight percent pick-up of predusts and between 4 and 12 weight percent pick-up of intermediates is typical.

Batter layers (including conventional batter layers and layers of the edible batter compositions of the present invention) may be applied to the food substrates using a batter enrober. One kind of batter enrober employs a trough of batter and a conveyor belt carrying the substrates into and through the batter. Typically the trough will be temperature controlled and batter will automatically be fed into the trough to replace the batter that is removed. Another kind of batter enrober, known as a curtain enrober, drops batter onto the food substrates from above. The batter may also be sprayed onto the food substrates. Such methods are well known by persons of skill in the art.

The present invention will now be discussed further by reference to the following examples.

### EXAMPLES

### Example 1

### Coating Procedures (Chicken Nuggets)

This example demonstrates one way in which batter-coated chicken nuggets are prepared industrially.
1. A chicken nugget substrate is formed using a forming machine. The chicken nugget substrate consists of chicken breast meat, water, salt, functional starch and phosphates.
2. The formed substrate is coated in a predust, which is applied between 2 and 15 weight percent pick-up, and typically 5 weight percent pick-up. The predust is applied by a predust coating machine which applies the predust and then blows off excess pick-up.
3. The nugget is cooked in a steam oven, 100% saturated steam and a temperature of 100° C. is used to cook the substrate as a safety measure. At this point weight is gained as the predust absorbs moisture from the steam oven—this is known as a yield gain.
4. The hot moist nuggets are then coated in an intermediate which adds weight and makes the surface of the product dry. Between 2 and 15 weight percent pick-up, and typically 5 weight percent pick-up of the intermediate is applied.
5. Tempura batter is then applied to the nugget substrate. The temperature of the batter could range from 5° C. to 25° C. though usually is around 10° C. Between 20 and 40 weight percent pick-up is usual.
6. The nugget is then flash/par-fried in vegetable oil at 180 to 200° C. for between 20 and 60 seconds.
7. The nugget is then frozen and packed.
8. The nugget is subsequently fully cooked in a deep fat fryer or oven in a restaurant or in a domestic kitchen.

This process can be summarised as: substrate, predust, steam, intermediate, tempura, flash fry, freeze. However, one of the following coating procedures could also easily have been used:
Substrate, predust, tempura, fry, freeze.
Substrate, predust, adhesion batter, intermediate, tempura, fry, freeze.
Substrate, adhesion batter, intermediate, tempura, fry, freeze.
Substrate, adhesion batter, adhesion batter, intermediate, tempura, fry, freeze.

### Example 2

### Coating Procedures (Battered Fish)

This example demonstrates one way in which batter-coated fish are prepared industrially.
1. Frozen cod tails are used for the substrate.
2. The frozen cod tail is passed through a steam curtain to remove surface ice.
3. An adhesion batter is applied onto the cod tail, between 5% and 10% pick-up by weight.
4. An intermediate is applied to the cod tail, between 5% and 12% pick-up by weight.
5. A tempura batter is applied to the cod tail, between 20 and 40% pick-up by weight.
6. The product is flash fried for 35 to 60 seconds at 180° C. to 205° C.
7. The product is then chilled or frozen and packaged.
8. The product is cooked in an oven, deep fried or grilled, in a restaurant or in a domestic kitchen.

This process can be summarised as: substrate, adhesion batter, intermediate, tempura, flash fry, freeze.

### Example 3

### Reduced Fat Chicken Nuggets

A 1% by weight solution of a protein mixture of myofibrillar and sarcoplasmic proteins derived from chicken (available commercially under the trade name “Nutrilean”, Proteus Industries, Gloucester, Mass., USA) was prepared by mixing the powdered protein with water in a food mixer.

A reduced fat tempura batter dry mix was prepared by combining wheat flour (40 to 45 wt %); maize flour (40 to 45 wt %); wheat starch (5 to 15 wt %); whey powder (1 to 4 wt %); neutralising amounts of sodium acid pyrophosphate (0.1 to 0.5 wt %) and sodium bicarbonate (0.1 to 0.4 wt %); and black pepper (0.2 to 1 wt %).

A standard tempura batter dry mix was prepared by combining wheat flour (40 to 45 wt %); maize flour (40 to 45 wt %); wheat starch (5 to 15 wt %); whey powder (1 to 4 wt %); neutralising amounts of sodium acid pyrophosphate (0.4 to 0.8 wt %) and sodium bicarbonate (0.2 to 0.6 wt %); salt (2 to 5 wt %); and black pepper (0.2 to 1 wt %).

The chicken protein solution was used to hydrate the reduced fat tempura batter dry mix at a ratio of 1.25 parts chicken protein solution to 1 part reduced fat tempura batter dry mix to form an edible batter composition according to the invention.

A comparative batter composition not containing protein was prepared by using water to hydrate the reduced fat tempura batter dry mix at a ratio of 1.25 parts water to 1 part reduced fat tempura batter dry mix.

A second comparative batter composition containing protein was prepared by using the chicken protein solution to hydrate the standard tempura batter dry mix at a ratio of 1.25 parts chicken protein solution to 1 part standard tempura batter dry mix.

A third comparative batter composition not containing protein was prepared by using water to hydrate the standard tempura batter dry mix at a ratio of 1.25 parts water to 1 part standard tempura batter dry mix.

The above batter compositions are summarised in Table 1.

TABLE 1

| | Standard | Reduced Fat | Standard | Reduced Fat |
|---|---|---|---|---|
| | Batter | Batter | Batter | Batter |
| | No Protein | No Protein | With Protein | With Protein* |
| Batter (wt %) | 44.4 | 44.4 | 44.4 | 44.4 |
| Water (wt %) | 55.6 | 55.6 | 55.0 | 55.0 |
| Chicken | 0 | 0 | 0.6 | 0.6 |
| Protein (wt %) | | | | |
| Alkali metal | 0.270 | 0.021 | 0.270 | 0.021 |
| (mol/kg) | | | | |

*Edible batter composition according to the invention

All tempura batters had the same viscosities. Frozen 12 g chicken nugget cores were used as meat substrates to be coated.

Twenty four frozen 12 g chicken nugget cores were coated with a standard adhesion batter, 5% pick-up by weight. The nuggets were then dusted in wheat flour (intermediate), 5% pick-up by weight. The nuggets were separated in to two batches of twelve. One batch of twelve nuggets was coated with the standard tempura batter with no protein (held at 14° C.) and flash fried for 23 seconds in rapeseed oil at 190° C. for 23 seconds and frozen at −18° C. The other batch of 12 was coated with the standard tempura batter including protein (held at 14° C.) and flash fried for 23 seconds in rapeseed oil at 190° C. for 23 seconds and frozen at −18° C.

A further twenty four frozen 12 g nugget cores were coated with a standard adhesion batter, 5% pick-up by weight. The nuggets were then dusted in wheat flour (a low sodium intermediate), 5% pick-up by weight. The nuggets were separated into two batches of twelve. One batch of twelve was coated with the reduced fat tempura batter with no protein (held at 14° C.) and flash fried for 23 seconds in rapeseed oil at 190° C. for 23 seconds and frozen at −18° C. The other batch of twelve was coated with the reduced fat tempura batter including protein (edible batter composition according to the invention) held at 14° C., and flash fried for 23 seconds in rapeseed oil at 190° C. for 23 seconds and frozen at −18° C.

Each batch of chicken nuggets was then reconstituted by frying in palm oil at 182° C. for 3 minutes and 15 seconds. All products were cooked for the same length of time so comparisons between the comparative products and the low fat products are true. After cooking the fryer basket is shaken 20 times and each batch of nuggets was placed into a nylon plastic bag which was then sealed. Each batch of nuggets was cooled to room temperature in a refrigerator. Once at room temperature each batch of nuggets was homogenised in a Kenwood food processor and placed back in the nylon bag ready for fat testing.

### Example 4

### Fat Analysis

Each batch of chicken nuggets prepared according to Example 3 was analysed for its fat content. Fat analysis was conducted on a Smart Trac Rapid Fat Analyzer (CEM, Buckingham, UK). A calibration curve was set up with a 5 points, 3 samples per point, using samples with fat levels ranging from 1% fat to 25% fat, confirmed in triplicate by a UCAS accredited Lab, Beverley Analytical Laboratories, Beverley, UK.

Two Smart Trac Sample Pads are tared on a balance. Between 3 g and 3.5 g of homogenised sample is placed on one of the Smart Trac Sample Pads, the sample is smeared across the pad and a second pad is placed on top of the sample. Pressure is placed on the pads to stick the sample between the two pads. The sample is dried in the microwave/infrared moisture analyser set to 100% power with a maximum dry time of 10 minutes. The sample is then rolled up inside a square of Smart Trac Film and placed into a sample tube. The sample tube is then placed into the NMR analyser and the sample is run for 64 seconds. Measurements were made in duplicate for each batch of nuggets and an average fat content was obtained.

The results of the fat analysis for each batch of chicken nuggets are summarised in Table 2.

TABLE 2

| | | | Average | | Fat Reduction |
|---|---|---|---|---|---|
| | | | Fat | Direct Fat | for Similar |
| | Fat (wt %) | | (wt %) | Reduction | Texture |
| Standard Batter | 12.2 | 12.2 | 12.2 | N/A | N/A |
| No Protein | | | | | |
| Standard Batter | 11.5 | 11.2 | 11.4 | 6.97% | N/A |
| With Protein | | | | | |
| Reduced Fat Batter | 9.1 | 9.1 | 9.1 | N/A | N/A |
| No Protein | | | | | |
| Reduced Fat Batter | 7.2 | 7.2 | 7.2 | 20.88% | 40.98% |
| With Protein* | | | | | |

*Edible batter composition according to the invention

As used herein, direct fat reduction refers to the fat reduction obtained in a particular batter composition when using the protein, compared to a corresponding batter composition that omits the protein. This clearly demonstrates the beneficial effect of a low concentration of alkali metal ions in reducing uptake of fat and/or oil when the protein is used.

Addition of the protein to the standard batter mix resulted in a significant change in texture. Addition of the protein to the reduced fat batter composition results in a lightening of the texture. The resulting texture is comparable to that of the standard batter containing no protein. The reduction in fat obtained without significant change in texture for this comparison is 40.98%.

### Example 5

### Taste Testing

Each batch of chicken nuggets prepared according to Example 3 was tested by an independent taste panel.

The colour, visual appeal (e.g. ripples, sheen), texture and flavour of the chicken nuggets were scored using a nine point hedonic scale:
0=very poor
3=marginally acceptable
6=very acceptable
9=outstanding

The results of these tests is summarised in Table 3

TABLE 3

| | Colour | Visuals | Texture | Flavour | Average |
|---|---|---|---|---|---|
| Standard Batter | 7 | 7 | 7 | 7 | 7 |
| No Protein | | | | | |
| Standard Batter | 4 | 4 | 3 | 5 | 4 |
| With Protein | | | | | |
| Reduced Fat Batter | 6 | 6 | 3 | 3 | 4.5 |
| No Protein | | | | | |
| Reduced Fat Batter | 7 | 7 | 7 | 6 | 6.75 |
| With Protein* | | | | | |

*Edible batter composition according to the invention

### Example 6

### Reduced Fat Battered Fish

A 1% by weight solution of a protein mixture of myofibrillar and sarcoplasmic proteins derived from Pollock (available commercially under the trade name “Nutrilean”, Proteus Industries, Gloucester, Mass., USA) was prepared by mixing the powdered protein with water in a food mixer.

A reduced fat tempura batter dry mix was prepared by combining wheat flour (65 to 75 wt %); maize flour (15 to 20 wt %); wheat starch (5 to 15 wt %); whey powder (1 to 4 wt %); and neutralising amounts of sodium acid pyrophosphate (0.1 to 0.5 wt %) and sodium bicarbonate (0.1 to 0.4 wt %).

A standard tempura batter dry mix was prepared by combining wheat flour (65 to 75 wt %); maize flour (15 to 20 wt %); wheat starch (5 to 15 wt %); whey powder (1 to 4 wt %); neutralising amounts of sodium acid pyrophosphate (0.5 to 0.9 wt %) and sodium bicarbonate (0.2 to 0.7 wt %); and salt (2 to 5 wt %).

The pollock protein solution was used to hydrate the reduced fat tempura batter dry mix at a ratio of 1.25 parts pollock protein solution to 1 part reduced fat tempura batter dry mix to form an edible batter composition according to the invention.

A comparative batter composition not containing protein was prepared by using water to hydrate the standard tempura batter dry mix at a ratio of 1.25 parts water to 1 part standard tempura batter dry mix.

Both tempura batters have the same viscosities.

The above batter compositions are summarised in Table 4.

TABLE 4

| | Standard | Reduced Fat |
|---|---|---|
| | Batter | Batter |
| | No Protein | With Protein* |
| Batter (wt %) | 44.4 | 44.4 |
| Water (wt %) | 55.6 | 55.0 |
| Pollock Protein (wt %) | 0 | 0.6 |
| Alkali metal (mol/kg) | 0.283 | 0.021 |

*Edible batter composition according to the invention

Frozen cod tails were cut to 50 g and to the same dimensions.

A batch of eight cod tails were coated in a standard adhesion batter, 6% pick-up by weight, and wheat flour (intermediate), 6% pick-up by weight, before applying the standard tempura batter held at 14° C., 24% pick-up by weight. These were then par-fried in rapeseed oil at 190° C. for 23 seconds and frozen at −18° C.

A further batch of eight cod tails were coated in a standard adhesion batter, 6% pick-up by weight, and wheat flour (low sodium intermediate), 6% pick-up by weight, before applying the reduced fat tempura batter including protein (edible batter composition according to the invention) held at 14° C., 24% pick-up by weight. These were then par-fried in rapeseed oil at 190° C. for 23 seconds and frozen at −18° C.

Four cod tails from each batch were reconstituted in palm oil at 182° C. for 3 minutes and four cod tails from each batch were reconstituted in an oven (Newhome S3-E700S fan assisted electric oven) at 200° C. for 15 minutes. Each batch of cod tails was cooled to room temperature in a refrigerator. Once at room temperature each batch of cod tails was homogenised in a Kenwood food processor and placed back in the nylon bag ready for fat testing.

### Example 7

### Fat Analysis

Each batch of cod tails prepared according to Example 6 was analysed for its fat content using a Smart Trac Rapid Fat Analyzer (CEM, Buckingham, UK) according to the procedure outlined in Example 4.

The results of the fat analysis for each batch of cod tails are summarised in Table 5.

TABLE 5

| | | Fat Content | | Average | |
|---|---|---|---|---|---|
| | Reconstitution | (wt %) | | (wt %) | Reduction¹ |
| Standard Batter | Fryer | 10.6 | 10.4 | 10.5 | N/A |
| No Protein | Oven | 5.1 | 5.5 | 5.3 | N/A |
| Reduced Fat | Fryer | 6.0 | 6.2 | 6.1 | 41.7% |
| Batter | | | | | |
| With Protein* | Oven | 3.4 | 3.6 | 3.5 | 33.6% |

*Edible batter composition according to the invention
¹Fat reduction when compared to standard batter reconstituted in the same way

The texture and appearance of the standard batter product and the reduced fat batter product according to the invention were comparable.

### Example 8

### Taste Testing

Each batch of battered cod tails prepared according to Example 6 was tested by an independent taste panel as in Example 5.

The results of these tests are summarised in Table 6.

TABLE 6

| | | Colour | Visuals | Texture | Flavour | Average |
|---|---|---|---|---|---|---|
| Standard Batter | Fryer | 7 | 6 | 7 | 7 | 6.75 |
| No Protein | Oven | 6 | 6 | 5 | 7 | 5 |
| Reduced Fat | Fryer | 7 | 6 | 6 | 5 | 6 |
| Batter | Oven | 6 | 6 | 5 | 5 | 5.5 |
| With Protein* | | | | | | |

*Edible batter composition according to the invention

The results show that there are only minor differences observed by consumers between reduced fat products and standard products. Significant fat reductions were seen for both oven bake and deep fry products.

### Example 9

### pH Effects

### Reduced Fat Tempura Batter Composition pH 5.7

A 1% by weight solution of a protein mixture of myofibrillar and sarcoplasmic proteins derived from chicken (available commercially under the trade name “Nutrilean”, Proteus Industries, Gloucester, Mass., USA) was prepared by mixing the powdered protein with water in a food mixer. The chicken protein solution was then used to hydrate the reduced fat tempura batter dry mix described in Example 3 at a ratio of 1.25 parts chicken protein solution to 1 part the reduced fat tempura batter dry mix to obtain an edible batter composition according to the invention. The pH was measured to be pH 5.7.

### Reduced Fat Tempura Batter Composition pH 3.3

The edible batter composition having pH 5.7 was prepared according to the method described above, and the pH was adjusted to pH 3.3 using concentrated phosphoric acid to obtain a further edible batter composition according to the invention.

### Standard Tempura Batter Composition pH 5.9

A comparative batter composition not containing protein was prepared by using water to hydrate the standard tempura batter dry mix described in Example 3 at a ratio of 1.25 parts water to 1 part standard tempura batter dry mix. The pH was measured to be pH 5.9.

The above batter compositions are summarised in Table 7.

TABLE 7

| | Standard | Reduced Fat | Reduced Fat |
|---|---|---|---|
| | Batter | Batter | Batter |
| | pH 5.9 | pH 5.7* | pH 3.3* |
| Batter (wt %) | 44.4 | 44.4 | 44.4 |
| Water (wt %) | 55.6 | 55.0 | 55.0 |
| Chicken Protein (wt %) | 0 | 0.6 | 0.6 |
| Alkali metal (mol/kg) | 0.27 | 0.021 | 0.021 |

*Edible batter composition according to the invention

All the batters had the same viscosity.

Twelve frozen 12 g chicken nugget cores were coated with a standard adhesion batter, 5% pick-up by weight. The nuggets were then dusted in wheat flour (intermediate), 5% pick-up by weight, and then coated with the standard tempura batter at pH 5.9 with no protein (held at 14° C.) and flash fried for 23 seconds in rapeseed oil at 190° C. for 23 seconds and frozen at −18° C.

Twenty four frozen 12 g nugget cores were coated with a standard adhesion batter, 5% pick-up by weight. The nuggets were then dusted in wheat flour (low sodium intermediate), 5% pick-up by weight. The nuggets were separated in to two batches of twelve. One batch of twelve was coated with the reduced fat tempura batter at pH 3.3 (edible batter composition according to the invention) held at 14° C. and flash fried for 23 seconds in rapeseed oil at 190° C. for 23 seconds and frozen at −18° C. The other batch of twelve was coated with the reduced fat tempura batter at pH 5.7 (edible batter composition according to the invention) held at 14° C., and flash fried for 23 seconds in rapeseed oil at 190° C. for 23 seconds and frozen at −18° C.

Each batch of chicken nuggets was then reconstituted by frying in palm oil at 182° C. for 3 minutes and 15 seconds. All products were cooked for the same length of time so comparisons between the comparative products and the low fat products are true. After cooking the fryer basket was shaken 20 times and each batch of nuggets was placed into a nylon plastic bag which was then sealed. Each batch of nuggets was cooled to room temperature in a refrigerator. Once at room temperature each batch of nuggets was homogenised in a Kenwood food processor and placed back in the nylon bag ready for fat testing.

### Example 10

### Fat Analysis

Each batch of chicken nuggets prepared according to Example 9 was analysed for its fat content using a Smart Trac Rapid Fat Analyzer (CEM, Buckingham, UK) according to the procedure outlined in Example 4.

The results of the fat analysis for each batch of chicken nuggets are summarised in Table 8.

TABLE 8

| | Fat | | Average Fat | Fat Reduction¹ |
|---|---|---|---|---|
| Standard Batter | 13.37 | 12.92 | 13.15 | N/A |
| pH 5.9 | | | | |
| Reduced Fat Batter | 9.65 | 9.81 | 9.73 | 25.98% |
| pH 5.7* | | | | |
| Reduced Fat Batter | 9.57 | 9.82 | 9.70 | 26.25% |
| pH 3.3* | | | | |

*Batter composition according to the invention
¹Relative to the standard batter of pH 5.9

These results show that the lowering of the pH has no affect on the fat reduction. Taste panels have shown that when an acid is used to reduce the pH there is a flavour imparted which is detrimental to the product.

### Example 11

### Comparison with Standard Commercially-Available Batter Compositions

This Example demonstrates that when the proteins described above are used in combination with standard commercially-available batter mixes, the resulting batter compositions are not as effective as reducing fat uptake as the compositions of the invention. Contrary to the disclosure in U.S. Pat. No. 7,163,707, it has been found that fat reduction and acceptable product quality is not obtained merely by addition of the protein to any batter composition.

Six numbered batter compositions were prepared as follows:
1. A reduced fat tempura batter composition according to the invention was prepared according to the method described in Example 6, using a 1% by weight solution of a protein mixture of myofibrillar and sarcoplasmic proteins derived from Pollock (available commercially under the trade name “Nutrilean”, Proteus Industries, Gloucester, Mass., USA).
2. A comparative tempura batter composition not containing protein was prepared by using water to hydrate the reduced fat tempura batter dry mix described in Example 3 at a ratio of 1.25 parts water to 1 part reduced fat tempura batter dry mix.
3. A Kerry Food Service Henry Jones Gold Batter tempura batter mix (wheat flour, salt, E450, E500, colourings, E170 and xanthan gum; Kerry Food Service Bristol UK) was hydrated with the Pollock protein solution described above at a ratio of 1.25 parts Pollock protein solution to 1 part Kerry Henry Jones Gold Batter tempura batter mix.
4. The Kerry Food Service batter mix described above was also hydrated using water, at a ratio of 1.25 parts water to 1 part Kerry Henry Jones Gold Batter tempura batter mix.
5. A Tazaki Foods tempura batter mix (wheat flour, E500, sesame powder, mustard, iron, thiamin (B1), riboflavin (B2) and folic acid; Tazaki Foods, Enfield, UK) was hydrated with the Pollock protein solution described above at a ratio of 1.25 parts Pollock protein solution to 1 part Tazaki Foods tempura batter mix.
6. The Tazaki Foods tempura batter mix described above was also hydrated using water, at a ratio of 1.25 parts water to 1 part Tazaki Foods tempura batter mix.

The compositions of the above batter compositions are summarised in Table 9.

TABLE 9

| Batter type (1-6) | 1* | 2 | 3 | 4 | 5 | 6 |
|---|---|---|---|---|---|---|
| Batter (wt %) | 43.9 | 44.4 | 43.9 | 44.4 | 43.9 | 44.4 |
| Water (wt %) | 55.55 | 55.6 | 55.55 | 55.6 | 55.55 | 55.6 |
| Pollock Protein | 0.55 | 0 | 0.55 | 0 | 0.55 | 0 |
| (wt %) | | | | | | |
| Alkali metal | 0.021 | 0.27 | 0.287 | 0.287 | 0.056 | 0.056 |
| (mol/kg) | | | | | | |

*Edible batter composition according to the invention

Frozen cod tails were cut to 50 g and to the same dimensions.

For each of the batter compositions 2, 4 and 6, eight frozen cod tails were coated in a standard adhesion batter, 6% pick-up by weight, and wheat flour (intermediate), 6% pick-up by weight, before applying the standard tempura batter held at 14° C., 24% pick-up by weight. These were then par-fried in rapeseed oil at 190° C. for 23 seconds and frozen at −18° C.

For each of the batter compositions 1, 3 and 5, eight frozen cod tails were coated in a standard adhesion batter, 6% pick-up by weight, and wheat flour (low sodium dry intermediate), 6% pick-up by weight, before applying the protein tempura batter held at 14° C., 24% pick-up by weight. These were then par-fried in rapeseed oil at 190° C. for 23 seconds and frozen at −18° C.

Products for each batter were reconstituted in palm oil at 182° C. for 3 minutes.

### Example 12

### Fat Analysis

Each batch of cod tails prepared according to Example 11 was analysed for its fat content using a Smart Trac Rapid Fat Analyzer (CEM, Buckingham, UK) according to the procedure outlined in Example 4.

The results of the fat analysis for each batch of chicken nuggets are summarised in Table 10.

TABLE 10

| | Type (1-6) | Fat Content | | Average | Reduction¹ |
|---|---|---|---|---|---|
| Reduced Fat | Protein (1)* | 6.71 | 6.69 | 6.70 | 30.45% |
| Tempura Batter | No Protein (2) | 4.70 | 4.62 | 4.66 | |
| Kerry Foods | Protein (3) | 7.36 | 7.47 | 7.42 | −31.29%² |
| | No Protein (4) | 9.81 | 9.66 | 9.74 | |
| Tazaki Foods | Protein (5) | 6.58 | 6.62 | 6.60 | −20.00% |
| Tempura Batter | No Protein (6) | 7.85 | 7.99 | 7.92 | |

*Edible batter composition according to the invention
¹Percentage fat reduction obtained by protein containing batters compared to non-protein-containing batters of the same type.
²Negative fat reduction indicates an increase in fat uptake.

### Example 13

### Taste Testing

Each batch of cod tails prepared according to Example 10 was tested by an independent taste panel as in Example 5.

The results of these tests are summarised in Table 11.

TABLE 11

| | | Col- | Visu- | Tex- | Fla- | Aver- |
|---|---|---|---|---|---|---|
| | Type (1-6) | our | als | ture | vour | age |
| Reduced Fat | Protein (1)* | 8 | 7 | 6 | 6 | 6.75 |
| Tempura Batter | No Protein (2) | 8 | 7 | 7 | 6 | 7 |
| Kerry Foods | Protein (3) | 3 | 4 | 1 | 4 | 3 |
| | No Protein (4) | 8 | 5 | 7 | 6 | 6.5 |
| Tazaki Foods | Protein (5) | 2 | 1 | 1 | 3 | 1.75 |
| Tempura Batter | No Protein (6) | 6 | 5 | 6 | 6 | 5.75 |

*Edible batter composition according to the invention

Both the Kerry and Tazaki protein-containing products were found to be much tougher, chewier, much oilier, containing raw flavour notes and there was a significant colour loss compared to the non-protein-containing batters.

These results show the need for a specifically designed batter for use with the protein. Simply adding the protein to a standard batter resulted in a significant loss of texture and an increase in fat pick-up.

### Example 14

### Methods of Mixing

This Example demonstrates the effect that correct mixing can have in increasing the fat reduction observed when using the edible batter compositions of the invention.

### Reduced Fat Tempura Batter Mix 1

To the reduced fat tempura batter dry mix described in Example 3 was added 1.2 wt % of dry chicken protein as described in Example 3 (Proteus Industries, Gloucester, Mass., USA). The mixture was hydrated with water at 1.25 parts water to 1 part reduced fat tempura batter dry mix.

### Reduced Fat Tempura Batter Mix 2

The reduced fat tempura batter dry mix described in Example 3 was thoroughly mixed with oil to evenly spread the oil over all ingredients. 1.2 weight percent of the dry chicken protein as described in Example 3 (Proteus Industries, Gloucester, Mass., USA) was added and the batter mix and protein were given a very gentle mix. The resulting mixture was hydrated with water at 1.25 parts water to 1 part reduced fat tempura batter dry mix.

### Reduced Fat Tempura Batter Mix 3

The reduced fat tempura batter dry mix described in Example 3 was hydrated using the chicken protein solution also described in Example 3, at a ratio of 1.25 parts chicken protein solution to 1 part reduced fat tempura batter dry mix.

### Standard Tempura Batter Mix

A comparative batter composition not containing protein was prepared by using water to hydrate the standard tempura batter dry mix described in Example 3 at a ratio of 1.25 parts water to 1 part standard tempura batter dry mix.

The above batter compositions are summarised in Table 12.

TABLE 12

| | Standard | Reduced Fat |
|---|---|---|
| | Batter | Batters 1*, 2*, 3* |
| Batter (wt %) | 44.4 | 43.87 |
| Water (wt %) | 55.6 | 55.6 |
| Pollock Protein (wt %) | 0 | 0.53 |
| Alkali metal (mol/kg) | 0.27 | 0.021 |

*Edible batter composition according to the invention

All tempura batters had the same viscosities.

Twelve frozen 12 g chicken nugget cores were coated with a precook predust 6% pick-up by weight, and cooked for 5 minutes in a Hobart Convection Steamer CSD-06126 Oven, London UK, on full steam 100° C. Wheat flour (intermediate), 6% pick-up by weight was applied before applying the standard tempura batter mix described above, held at 14° C., 24% pick-up by weight. The nuggets were then flash fried in rapeseed oil at 195° C. for 23 seconds and frozen at −18° C.

Twelve frozen 12 g chicken nugget cores were coated with a precook predust 6% pick-up by weight, and cooked for 5 minutes in a Hobart Convection Steamer CSD-06126 Oven, London UK, on full steam 100° C. Wheat flour (low sodium intermediate), 6% pick-up by weight was applied before applying the reduced fat tempura batter mix 1 described above (edible batter composition according to the invention), held at 14° C., 24% pick-up by weight. The nuggets were then flash fried in rapeseed oil at 195° C. for 23 seconds and frozen at −18° C.

Twelve frozen 12 g chicken nugget cores were coated with a precook predust 6% pick-up by weight, and cooked for 5 minutes in a Hobart Convection Steamer CSD-06126 Oven, London UK, on full steam 100° C. Wheat flour (low sodium intermediate), 6% pick-up by weight was applied before applying the reduced fat tempura batter mix 2 described above (edible batter composition according to the invention), held at 14° C., 24% pick-up by weight. The nuggets were then flash fried in rapeseed oil at 195° C. for 23 seconds and frozen at −18° C.

Twelve frozen 12 g chicken nugget cores were coated with a precook predust 6% pick-up by weight, and cooked for 5 minutes in a Hobart Convection Steamer CSD-06126 Oven, London UK, on full steam 100° C. Wheat flour (low sodium intermediate), 6% pick-up by weight was applied before applying the reduced fat tempura batter mix 3 described above (edible batter composition according to the invention), held at 14° C., 24% pick-up by weight. The nuggets were then flash fried in rapeseed oil at 195° C. for 23 seconds and frozen at −18° C.

Each batch of chicken nuggets was then reconstituted by frying in palm oil at 182° C. for 3 minutes and 15 seconds.

Half of the nuggets were analysed for fat content, the other half were tested by a taste panel.

### Example 15

### Fat Analysis

Each batch of chicken nuggets prepared according to Example 14 was analysed for its fat content using a Smart Trac Rapid Fat Analyzer (CEM, Buckingham, UK) according to the procedure outlined in Example 4.

The results of the fat analysis for each batch of chicken nuggets are summarised in Table 13.

TABLE 13

| | Fat Content | | | |
|---|---|---|---|---|
| | (wt %) | | Average (wt %) | Reduction¹ |
| Standard Tempura | 14.86 | 14.12 | 14.49 | N/A |
| Batter | | | | |
| Reduced Fat | 12.63 | 12.25 | 12.44 | 13.01 |
| Tempura Batter 1* | | | | |
| Reduced Fat | 10.56 | 10.03 | 10.30 | 28.01 |
| Tempura Batter 2* | | | | |
| Reduced Fat | 11.22 | 10.84 | 11.03 | 22.87 |
| Tempura Batter 3* | | | | |

*Batter composition according to the invention
¹Percentage fat reduction obtained by protein containing batters compared to standard tempura batter

This Example clearly demonstrates that optimum fat reduction is obtained when the batter composition is prepared by a method which ensures full hydration of the protein and/or peptide mixture.

### Example 16

### Taste Testing

Each batch of chicken nuggets prepared according to Example 14 was tested by an independent taste panel as in Example 5.

The results of these tests are summarised in Table 14.

TABLE 14

| | Colour | Visuals | Texture | Flavour | Average |
|---|---|---|---|---|---|
| Standard Tempura | 7 | 7 | 7 | 6 | 6.75 |
| Batter | | | | | |
| Reduced Fat | 6 | 5 | 4 | 5 | 5 |
| Tempura Batter 1* | | | | | |
| Reduced Fat | 6 | 6 | 6 | 5 | 5.75 |
| Tempura Batter 2* | | | | | |
| Reduced Fat | 6 | 6 | 6 | 5 | 5.75 |
| Tempura Batter 3* | | | | | |

*Batter composition according to the invention

The results show that there are only minor differences observed by consumers between reduced fat products and standard products, even where the specified mixing techniques provide as much as 30% fat reduction.

1. An edible batter composition for frying in at least one of fat or oil, said edible batter composition comprising:
(a) 27 to 57 weight percent flour;
(b) 40 to 70 weight percent water; and
(c) 0.15 to 3.0 weight percent of at least one of a protein or a peptide mixture derived from animal muscular tissue, and
wherein the edible batter composition comprises less than or equal to 0.030 mol/kg of alkali metal ions.

2. An edible batter composition according to claim 1, wherein the at least one of protein or a peptide mixture derived from animal muscular tissue is obtained from fish, poultry or meat.

3. An edible batter composition according to claim 1, wherein the at least one of protein or peptide mixture is selected from at least one member of a group consisting of:
(i) a protein mixture of myofibrillar and sarcoplasmic proteins derived from animal tissue; and (ii) a peptide mixture prepared by enzymatic degradation of a protein mixture of myofibrillar and sarcoplasmic proteins derived from animal tissue.

4. An edible batter composition according to claim 1, comprising from 0.25 to 2.0 weight percent of the at least one of protein or peptide mixture.

5. An edible batter composition according to claim 4, wherein the composition comprises from 0.5 to 1.0 weight percent of the at least one of protein or peptide mixture.

6. An edible batter composition according to claim 1, wherein the edible batter composition comprises less than or equal to 0.025 mol/kg of alkali metal ions.

7. An edible batter composition according to claim 6, wherein the edible batter composition comprises less than or equal to 0.020 mol/kg of alkali metal ions.

8. An edible batter composition according to claim 1, further comprising a chemical or biological leavening system.

9. An edible batter composition according to claim 8, wherein the chemical leavening system comprises at least one alkaline leavening agent and at least one acidic leavening agent which react together to form carbon dioxide gas.

10. An edible batter composition according to claim 8, wherein the chemical leavening system comprises at least one alkaline leavening agents selected from a group consisting of: sodium bicarbonate, sodium carbonate, ammonium bicarbonate, ammonium carbonate, potassium bicarbonate, potassium carbonate, and potassium bitartrate.

11. An edible batter composition according to claim 8, wherein the chemical leavening system comprises at least one acidic leavening agents selected from a group consisting of: monocalcium phosphate, dicalcium phosphate, monosodium phosphate, sodium aluminium phosphate, and sodium acid pyrophosphate.

12. An edible batter composition according to claim 10, wherein the chemical leavening system comprises sodium bicarbonate, sodium acid pyrophosphate and monocalcium phosphate.

13. An edible batter composition according to claim 8, wherein the chemical leavening system provides greater than 90 mole percent of the alkali metal ions in the edible batter composition.

14. An edible batter composition according to claim 1, wherein the flour comprises from 0 to 100 weight percent wheat flour, from 0 to 100 weight percent maize flour and from 0 to 30 weight percent rice flour.

15. An edible batter composition according to claim 1, comprising from 1.5 to 18 weight percent of at least one of native or modified starch.

16. An edible batter composition according to claim 15, wherein the starch is selected from at least one member of a group consisting of: native wheat starch, modified wheat starch, native maize starch, modified maize starch, native rice starch, modified rice starch, native pea starch, modified pea starch, native tapioca starch, modified tapioca starch, native potato starch, and modified potato starch.

17. An edible batter composition according to claim 1, further comprising up to 10 weight percent relative to the edible batter composition of at least one coloring agent selected from a group consisting of: milk powder, skim milk powder, whey powder, dextrose, lactose, turmeric extract and paprika extract.

18. An edible batter composition according to claim 1, further comprising up to 6 weight percent of at least one of an edible fat or oil relative to the edible batter composition.

19. An edible batter composition according to claim 18, wherein the edible oil comprises at least one member of a group consisting of: sunflower oil, rapeseed oil, maize oil, groundnut oil, sesame oil, soybean oil and palm oil.

20. An edible batter composition according to claim 1, having a pH in the range of from 5.0 to 9.0.

21. An edible batter composition according to claim 1, wherein the composition does not include an acidifying agent other than as part of the chemical leavening system, wherein the composition does not include a basifying agent other than as part of the chemical leavening system.

22. A precursor composition for preparing an edible batter composition having (a) 27 to 57 weight percent flour; (b) 40 to 70 weight percent water; and (c) 0.15 to 3.0 weight percent of a protein and/or peptide mixture derived from animal muscular tissue, and wherein the edible batter composition comprises less than or equal to 0.030 mol/kg of alkali metal ions, the precursor composition comprising:
(a) 45 to 95 weight percent flour; and
(b) 0.25 to 5.0 weight percent of a dry protein and/or peptide mixture derived from animal muscular tissue, and
wherein the precursor composition comprises less than or equal to 0.050 mol/kg of alkali metal ions.

23. A precursor composition according to claim 22, comprising from 0.40 to 3.4 weight percent of the at least one of protein or peptide mixture.

24. A precursor composition according to claim 23, comprising from 0.8 to 1.7 weight percent of the at least one of protein or peptide mixture.

25. A precursor composition according to claim 22, wherein the precursor composition comprises less than or equal to 0.042 mol/kg of alkali metal ions.

26. A precursor composition according to claim 25, wherein the precursor composition comprises less than or equal to 0.033 mol/kg of alkali metal ions.

27. A precursor composition according to claim 22, further comprising a chemical or biological leavening system.

28. A precursor composition according to claim 27, wherein the chemical leavening system comprises at least one alkaline leavening agent and at least one acidic leavening agent which react together to form carbon dioxide gas.

29. A precursor composition according to claim 27, wherein the chemical leavening system provides greater than 90 mole percent of the alkali metal ions in the precursor composition.

30. A precursor composition according to claim 22, wherein the flour comprises from 0 to 100 weight percent wheat flour, from 0 to 100 weight percent maize flour and from 0 to 30 weight percent rice flour.

31. A precursor composition according to claim 22, comprising from 2.5 to 30 weight percent of native or modified starch.

32. A precursor composition according to claim 31, wherein the starch is selected from at least one member of a group consisting of native wheat starch, modified wheat starch, native maize starch, modified maize starch, native rice starch, modified rice starch, native pea starch, modified pea starch, native tapioca starch and modified tapioca starch.

33. A precursor composition according to claim 22, which further comprises up to 15 weight percent relative to the precursor composition of at least one coloring agent selected from at least one member of a group consisting of: milk powder, skim milk powder, whey powder, dextrose, lactose, turmeric extract and paprika extract.

34. A precursor composition according to claim 22, further comprising up to 10 weight percent of at least one of an edible fat or oil relative to the precursor composition.

35. A precursor composition according to claim 34, wherein the edible oil comprises at least one member of a group consisting of sunflower oil, rapeseed oil, maize oil, groundnut oil, sesame oil, soybean oil and palm oil.

36. A precursor composition according to claim 34, preparable by:
(i) mixing all of the components of the precursor composition except for the at least one of protein or peptide mixture in a mixing apparatus so as to form a blended composition coated in the at least one of edible fat or oil
(ii) mixing the at least one of the dry protein or peptide mixture with the blended composition from step (i) such that the at least one of the dry protein or peptide mixture remains substantially uncoated by the at least one of edible fat or oil.

37. A precursor composition according to claim 22, which provides an edible batter composition having a pH in the range of from 5.0 to 9.0. when 60 to 30 parts by weight of the precursor composition are blended with 40 to 70 parts by weight of water, to obtain a total of 100 parts by weight.

38. A method of preparing an edible batter composition having (a) 27 to 57 weight percent flour; (b) 40 to 70 weight percent water; and (c) 0.15 to 3.0 weight percent of at least one of a protein or peptide mixture derived from animal muscular tissue, and wherein the edible batter composition comprises less than or equal to 0.030 mol/kg of alkali metal ions, the method comprising:
adding 40 to 70 parts by weight of water to 60 to 30 parts by weight of a precursor composition having (a) 45 to 95 weight percent flour; and (b) 0.25 to 5.0 weight percent of at least one of a dry protein or peptide mixture derived from animal muscular tissue to obtain a total of 100 parts by weight, wherein the precursor composition comprises less than or equal to 0.050 mol/kg of alkali metal ions.

39. A method according to claim 38, wherein the precursor composition further includes up to 10 weight percent of at least one of an edible fat or oil relative to the precursor composition, wherein the precursor composition is preparable by:
(i) mixing all of the components of the precursor composition except for the at least one of protein or peptide mixture in a mixing apparatus so as to form a blended composition coated in the at least one of edible fat or oil;
(ii) mixing the at least one of dry protein or peptide mixture with the blended composition from step (i) such that the at least one of dry protein or peptide mixture remains substantially uncoated by the at least one of edible fat or oil.

40. A method of preparing an edible batter composition having (a) 27 to 57 weight percent flour; (b) 40 to 70 weight percent water; and (c) 0.15 to 3.0 weight percent of at least one of a protein or peptide mixture derived from animal muscular tissue, and wherein the edible batter composition comprises less than or equal to 0.030 mol/kg of alkali metal ions, the method comprising the steps of:
(i) dissolving the at least one of protein or peptide mixture in water to form at least one of a protein or peptide solution; and
(ii) combining the at least one of protein or peptide solution from step (i) with remaining components of the edible batter composition to form a slurry.

41. A method of preparing a food product comprising:
providing a food substrate with a coating layer of an edible batter composition, wherein the edible batter composition includes (a) 27 to 57 weight percent flour; (b) 40 to 70 weight percent water; and (c) 0.15 to 3.0 weight percent of at least one of a protein or peptide mixture derived from animal muscular tissue, and wherein the edible batter composition comprises less than or equal to 0.030 mol/kg of alkali metal ions, and
frying the batter-coated food substrate in at least one of oil or fat to provide a cooked or part-cooked batter-coated food substrate.

42. A method according to claim 41, wherein the food substrate is selected from at least one member of a group consisting of: fish, poultry, meat, vegetable and fruit.

43. A method according to claim 42, wherein the food substrate is selected from at least one member of a group consisting of: finfish, chicken, turkey, duck, pork, beef, and venison.

44. A method according to claim 42, wherein the food substrate is poultry, and wherein the at least one of protein or peptide mixture is derived from poultry.

45. A method according to claim 42, wherein the food substrate is fish, and wherein the at least one of protein or peptide mixture is derived from fish.

46. A method according to claim 42, wherein the food substrate is meat, and wherein the at least one of protein or peptide mixture is derived from meat.

47. A method according to claim 41, wherein the cooked or part-cooked batter-coated food substrate is subsequently chilled or frozen.

48. A method according to claim 47, wherein the chilled or frozen cooked batter-coated food substrate is reheated by at least one member of a group consisting of: frying in oil, frying in fat and oven baking.

49. A method according to claim 47, wherein the frozen batter-coated food substrate is sprayed with a flavour-enhancing quantity of salt water, wherein the salt water freezes on contact with the frozen batter-coated food substrate.

50. A method according to claim 41, wherein the part-cooked batter-coated food substrate is subsequently fully cooked by at least one member of a group consisting of: frying in oil, frying in fat, and oven baking.

51. A method according to claim 41, wherein the food substrate is provided with a plurality of coating layers, of which at least one coating layer is of the batter composition.

52. A method according to claim 51, wherein at least the outer coating layer is of the edible batter composition.

53. A method according to claim 51, wherein a predust coating layer is applied directly to the food substrate.

54. A method according to claim 51, wherein the food substrate is additionally provided with at least one layer of a conventional edible batter.

55. A method according to claim 51, wherein the food substrate is additionally provided with at least one layer of an intermediate selected from at least one member of a group consisting of: breadcrumb, rusk and flour.

56. A food product preparable by:
providing a food substrate with a coating layer of an edible batter composition, wherein the edible batter composition includes (a) 27 to 57 weight percent flour; (b) 40 to 70 weight percent water; and (c) 0.15 to 3.0 weight percent of at least one of a protein or peptide mixture derived from animal muscular tissue, and wherein the edible batter composition comprises less than or equal to 0.030 mol/kg of alkali metal ions, and
frying the batter-coated food substrate in at least one of oil or fat to provide a cooked or part-cooked batter-coated food substrate.

57. A food product comprising:
a food substrate having a coating layer of an edible batter composition the edible batter composition comprising:
(a) 27 to 57 weight percent flour;
(b) 40 to 70 weight percent water; and
(c) 0.15 to 3.0 weight percent of at least one of a protein or peptide mixture derived from animal muscular tissue, and
wherein the edible batter composition comprises less than or equal to 0.030 mol/kg of alkali metal ions.

58. A food product according to claim 57, wherein the food substrate has been cooked or part-cooked by frying in at least one of fat or oil.

59. A food product according to claim 56, wherein the food substrate is selected from at least one member of a group consisting of: fish, poultry, meat, vegetable and fruit.

60. A food product according to claim 59, wherein the food substrate is selected from at least one member of a group consisting of: finfish, chicken, turkey, duck, pork, beef, and venison.

61. A food product according to claim 59, wherein the food substrate is poultry, and wherein the at least one of protein or peptide mixture is derived from poultry.

62. A food product according to claim 59, wherein the food substrate is fish, and wherein the at least one of protein or peptide mixture is derived from fish.

63. A food product according to claim 59, wherein the food substrate is meat, and wherein the at least one of protein or peptide mixture is derived from meat.

64. A food product according to claim 57, which is chilled or frozen.

65. A food product according to claim 64, which is frozen and which is provided with a flavour-enhancing coating of salt water before or after being frozen.

66. A food product according to claim 57, wherein the food substrate is provided with a plurality of coating layers, of which at least one coating layer comprises the edible batter composition.

67. A food product according to claim 66, wherein at least the outer coating layer comprises the edible batter composition.

68. A food product according to claim 66, wherein the food substrate is additionally provided with a predust coating layer applied directly to the food substrate.

69. food product according claim 66, wherein the food substrate is additionally provided with at least one layer of a conventional edible batter.

70. A food product according to claim 66, wherein the food substrate is additionally provided with at least one layer of an intermediate, wherein the intermediate is selected from at least one member of a group consisting of: breadcrumb, rusk, flour and cracker meal.

71.-72. (canceled)
